(19) United States
(12) Patent Application Publication
(10) Pub. No.: US 2025/0158961 A1
(43) Pub. Date: May 15, 2025

(54) SYSTEM AND METHOD FOR PREFERENTIAL ADVERTISEMENT FILTERING TRAINED OVER HIERARCHICAL DISTRIBUTION

(71) Applicant: Samsung Electronics Co., Ltd., Suwon-si (KR)

(72) Inventors: Jan Christian Blaise Bombio CRUZ, Taguig City (PH); Juan Raphael Sabagay SEÑA, Taguig City (PH); Wilbert Jethro Ramirez LIMJOCO, Taguig City (PH); Rene Josiah Monta QUINTO, Taguig City (PH); Marc Dominic SAN PEDRO, Taguig City (PH); Marc Patrick Cruz CELON, Taguig City (PH); Alexander Nasa VILLASOTO, Taguig City (PH)

(21) Appl. No.: 19/025,144

(22) Filed: Jan. 16, 2025

Related U.S. Application Data
(63) Continuation of application No. PCT/KR2024/095961, filed on Aug. 1, 2024.

(30) Foreign Application Priority Data
Aug. 24, 2023 (PH) 1-2023-050459

(51) Int. Cl. H04L 9/40; G06F 3/0484

(52) U.S. Cl. CPC H04L 63/0245; G06F 3/0484

(57) ABSTRACT

An electronic apparatus is provided. The electronic apparatus includes memory configured to store a first sub model corresponding to a main model and one or more computer programs, the main model being stored in a server, and the first sub model being obtained by reducing a size of the main model, communication circuitry configured to communicate with the server including the main model, a display and one or more processors communicatively coupled to the communication circuitry, the display, and the memory, wherein the one or more computer programs include computer-executable instructions that, when executed by the one or more processors individually or collectively, cause the electronic apparatus to control the display to display a first screen including an advertisement, obtain a first user input for blocking the advertisement, obtain a second screen without the advertisement as inputting the first screen and the first user input into the first sub model, control the display to display the second screen without the advertisement, based on a first pre-determined event being identified, obtain first user data including the first user input, the first screen and the second screen, and obtain a second sub model by re-training the first sub model based on the first user data.

### CROSS-REFERENCE TO RELATED APPLICATION(S)

This application is a continuation application, claiming priority under § 365 (c), of an International application No. PCT/KR2024/095961, filed Aug. 1, 2024, which is based on and claims the benefit of a Philippine patent application number 1-2023-050459, filed on Aug. 24, 2023, in the Intellectual Property Office of the Philippines, the disclosure of which is incorporated by reference herein in its entirety.

### TECHNICAL FIELD

The disclosure relates to an artificial intelligence (AI)-optimized advertisement filtering system that aims to support personalized ad blocking. More particularly, the disclosure relates to a method for said AI-optimized advertisement filtering.

### BACKGROUND ART

Advertisement (Ad) blockers are extensions, applications, or services that prevent a browser or application from downloading unwanted elements of content a user is accessing. The most prevalent form of ad blocking today is rule based, which mainly utilizes regular expressions (regexes) that follow a certain syntax to determine if a resource should be blocked or not. Ads are blocked through a combination of two methods, namely through blocking network requests and hypertext markup language (HTML) elements, and there are specific rules that exist to handle each.

Rules to handle network requests focus on resource blocking, which rely on regular expressions that match either exact domains or parts of domains. Once a rule matches a network request, said network request will be blocked causing the load to fail. Rules to handle HTML elements, also known as cosmetic filters, also use regexes to specify the domain/s where rules should apply to, and cascading style sheets (CSS) rules syntax to hide elements.

Ad blocker development, however, is experiencing several challenges. Certain developments in Chromium extensions Application Programming Interface (API) standards (e.g., Manifest V3) threaten to break the functionality of current ad blockers. One of the main threats is the imposition of a heavy limit on the number of filters that can be enabled (5,000 unique rules), which is far too small for most popular filter lists, much less for multiple filter lists simultaneously. Due to these new restrictions, Manifest V3 poses a significant threat to rule-based ad blockers.

Another problem of rule-based ad blockers is the delay between the reporting of a new ad and adding it to a filter list. As an example, for Samsung Internet (SI), the internal process typically takes about 1-2 days. It begins with user reporting, then a team will inspect the site and identify what rules to add. Once this is done, it is reported to the external team which conducts their own investigation and updates their filter lists as necessary. Externally, the repositories of most big ad blockers' filter lists are updated quite frequently, about 10-20 times a day.

Another challenge with rule-based ad blockers is that some of them are too aggressive in blocking ads, and as a result, is hurting the revenue of publishers. One way to address this concern is to have an acceptable ads standard that respects user privacy, and an easier way to allow acceptable ads.

The disclosure solves these and other problems by providing a system that allows user preferred ads via crowdsourced feedback that is fed to a privacy-preserving machine learning architecture, so that user preferred ads are more easily allowed. This lets consumers support businesses and websites more easily, thus solving the unintended consequence of the proliferation of unwanted ads resulting from the increase in privacy.

U.S. patent application No. 20180075459A1 discloses a neural network-based inferential advertising system and method that delivers interactive advertisements to advertisement recipients in accordance with user-selected restrictions that inform the behavioral information upon which advertising preference inferences are made, as well as advertising preference inferences that are made based upon interpretations made from content by a computer-implemented neural network. The behavioral information upon which advertising inferences are made may include bodily movements of advertisement recipients that are performed without physical interaction with a device. Interactions by advertising recipients with delivered advertisements may include oral and gesture-based interactions.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an AI-optimized advertisement filtering system that makes use of a robust privacy-preserving machine learning architecture to detect and block newer, smarter, and more well-hidden ads more quickly, addressing the limitations of rule-based ad blocking.

Another aspect of the disclosure is to provide a system and method that reduces the delay and effort between ad reporting and effect, thereby reducing the amount of time unwanted ads, including malicious ads, seen by users.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes memory configured to store a first sub model corresponding to a main model and one or more computer programs, the main model being stored in a server, and the first sub model being obtained by reducing a size of the main model, communication circuitry configured to communicate with the server including the main model, a display and one or more processors communicatively coupled to the communication circuitry, the display, and the memory, wherein the one or more computer programs include computer-executable instructions that, when executed by the one or more processors individually or collectively, cause the electronic apparatus to control the display to display a first screen including an advertisement, obtain a first user input for blocking the advertisement, obtain a second screen without the advertisement as inputting the first screen and the first user input into the first sub model, control the display to display the second screen without the advertisement, based on a first pre-determined event being identified, obtain first user data including the first user input, the first screen and the second screen, and obtain a second sub model by re-training the first sub model based on the first user data.

The main model is obtained by training on the server. The first sub model is obtained by training the main model, on the server, based on at least one of knowledge distillation or quantization.

The one or more computer programs further include computer-executable instructions that, when executed by the one or more processors individually or collectively, cause the electronic apparatus to through the communication circuitry, receive the first sub model from the server, and store the first sub model in the memory.

The one or more computer programs further include computer-executable instructions that, when executed by the one or more processor s individually or collectively, cause the electronic apparatus to obtain the second screen by performing a function for blocking an advertisement through the first sub model.

The first pre-determined event includes an event for executing a training mode related to the function for blocking the advertisement of the sub model.

Based on a second pre-determined event being identified, the one or more computer programs further include computer-executable instructions that, when executed by the one or more processors individually or collectively, cause the electronic apparatus to, through the communication circuitry, transmit the second sub model to the server.

The second pre-determined event includes an event indicating that a pre-determined period has elapsed.

The first sub model is stored in another electronic apparatus. The server may receive a third sub model from the other electronic apparatus. The third sub model is obtained by re-training the first sub model based second user data of the other electronic apparatus.

The one or more computer programs further include computer-executable instructions that, when executed by the one or more processors individually or collectively, cause the electronic apparatus to, through the communication circuitry, receive a fourth sub model from the server, store the fourth sub model in the memory. The main model is a first main model. The fourth sub model is obtained by re-training a second main model, on the server, based on at least one of Knowledge Distillation or Quantization. The second main model is obtained by re-training the first main model, on the server, based on the second sub model and the third sub model.

The one or more computer programs further include computer-executable instructions that, when executed by the one or more processors individually or collectively, cause the electronic apparatus to obtain a hypertext markup language (HTML) element and a network element based on the first screen, and obtain the second screen without the advertisement as inputting the HTML element, the network element and the first user input into the first sub model.

In accordance with another aspect of the disclosure, a method performed by an electronic apparatus storing a first sub model corresponding to a main model, wherein the main model is stored in a server, and wherein the first sub model is obtained by reducing a size of the main model is provided. The controlling method includes displaying, by the electronic apparatus, a first screen including an advertisement, obtaining, by the electronic apparatus, a first user input for blocking the advertisement, obtaining, by the electronic apparatus, a second screen without the advertisement as inputting the first screen and the first user input into the first sub model, displaying, by the electronic apparatus, the second screen without the advertisement, based on a first pre-determined event being identified, obtaining, by the electronic apparatus, first user data including the first user input, the first screen and the second screen, and obtaining, by the electronic apparatus, a second sub model by re-training the first sub model based on the first user data.

The main model is obtained by training on the server. The first sub model is obtained by training the main model, on the server, based on at least one of Knowledge Distillation or Quantization.

The method further includes receiving the first sub model from the server, and storing the first sub model.

The obtaining the second screen comprises obtaining the second screen by performing a function for blocking an advertisement through the first sub model.

The first pre-determined event includes an event for executing a training mode related to the function for blocking the advertisement of the sub model.

In accordance with another aspect of the disclosure, one or more non-transitory computer-readable storage media storing one or more computer programs including computer-executable instructions that, when executed by one or more processors of an electronic apparatus individually or collectively, cause the electronic apparatus to perform operations, the operations including storing, by the electronic apparatus, a first sub model corresponding to a main model, the main model being stored in a server, and the first sub model being obtained by reducing a size of the main model, displaying, by the electronic apparatus, a first screen including an advertisement, obtaining, by the electronic apparatus, a first user input for blocking the advertisement, obtaining, by the electronic apparatus, a second screen without the advertisement as inputting the first screen and the first user input into the first sub model, displaying, by the electronic apparatus, the second screen without the advertisement, based on a first pre-determined event being identified, obtaining, by the electronic apparatus, first user data including the first user input, the first screen and the second screen, and obtaining, by the electronic apparatus, a second sub model by re-training the first sub model based on the first user data.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 illustrates a block diagram of a system for preferential advertisement filtering trained over hierarchical distribution according to an embodiment of the disclosure;

FIG. 2 illustrates a flow chart of a method for preferential advertisement filtering trained over hierarchical distribution according to an embodiment of the disclosure;

FIG. 3 illustrates a workflow process for generating an AI-based Ad Identifier Model of a system according to an embodiment of the disclosure;

FIG. 4 illustrates a workflow process for user personalization of a system according to an embodiment of the disclosure;

FIG. 5 illustrates a system for performing an advertisement blocking according to an embodiment of the disclosure;

FIG. 6 is a block diagram illustrating an electronic apparatus according to an embodiment of the disclosure;

FIG. 7 is a block diagram illustrating an electronic apparatus in a network environment according to an embodiment of the disclosure;

FIG. 8 illustrates a system for performing an advertisement blocking according to an embodiment of the disclosure;

FIG. 9 illustrates a screen including an advertisement according to an embodiment of the disclosure;

FIG. 10 illustrates user input for blocking the advertisement according to an embodiment of the disclosure;

FIG. 11 illustrates a screen for user's feedback according to an embodiment of the disclosure;

FIG. 12 illustrates a screen for purchasing a service for blocking an advertisement according to an embodiment of the disclosure;

FIG. 13 illustrates blocking operation of an electronic apparatus according to an embodiment of the disclosure;

FIG. 14 illustrates blocking operation of an electronic apparatus according to an embodiment of the disclosure;

FIG. 15 illustrates operation for storing a sub model according to an embodiment of the disclosure;

FIG. 16 illustrates operation for training a first sub model on a first electronic apparatus according to an embodiment of the disclosure;

FIG. 17 illustrates operation for training a first sub model on a second electronic apparatus according to an embodiment of the disclosure;

FIG. 18 illustrates operation for training the sub model without changing a screen according to an embodiment of the disclosure;

FIG. 19 illustrates operation for training a first main model on a server according to an embodiment of the disclosure;

FIG. 20 illustrates a third pre-determined event according to an embodiment of the disclosure;

FIG. 21 illustrates a third pre-determined event according to an embodiment of the disclosure;

FIG. 22 illustrates a third pre-determined event according to an embodiment of the disclosure;

FIG. 23 illustrates a third pre-determined event according to an embodiment of the disclosure;

FIG. 24 illustrates operation of using type information of the user input according to an embodiment of the disclosure;

FIG. 25 illustrates the main model according to an embodiment of the disclosure;

FIG. 26 illustrates training the main model according to an embodiment of the disclosure;

FIG. 27 illustrates operation for Adapter (sub model) Training according to an embodiment of the disclosure;

FIG. 28 illustrates operation for updating the sub model according to an embodiment of the disclosure;

FIG. 29 illustrates Region-based Hierarchical Distribution according to an embodiment of the disclosure; and

FIG. 30 illustrates controlling method of an electronic apparatus according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The following are definitions of terms as used in the various examples of the disclosure.

The term “Ad Identifier Model” or “AIM” as used herein refers to the model used for determining whether various network requests and HTML elements are advertisements or not.

The term “differential privacy” as used herein refers to the mathematical framework for ensuring the privacy of individuals in datasets. There are several techniques or algorithms that can be used to ensure differential privacy so long as an observer seeing its output cannot tell whether a particular individual's information was used in the computation.

The term “low-rank adapters” or “LoRA” as used herein refers to a training method that accelerates the training of large models while consuming less memory. In this method, pairs of rank-decomposition weight matrices (called update matrices) are added to existing weights, and only those newly added weights are trained.

The disclosure provides a system for preferential advertisement filtering trained over hierarchical distribution comprising: an at least one main module which has an ad identification function and is connected to an at least one personalization module; at least one personalization module augmented to the main module which serves as an ad identification function personalized to a user through an at least one user preference; a subscriber-side subsystem comprising of the at least one main module and the at least one augmented personalization module which learns the personalization preference of the user via an at least one adapter; and a direct upstream-side subsystem consisting of the main module which updates the other main modules in the subscriber-side subsystem for an at least one aggregated group preference through the collated information from the hierarchical distributed system.

The disclosure also provides a method for preferential advertisement filtering trained over hierarchical distribution comprising: generating personalization data in an at least one personalization module of an at least one subscriber-side subsystem in a hierarchical distributed architecture; collecting the generated personalization data from the at least one personalization module; generating a main module based on the collected personalization data; and updating the main module within an at least one subscriber-side subsystem using the generated main module.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

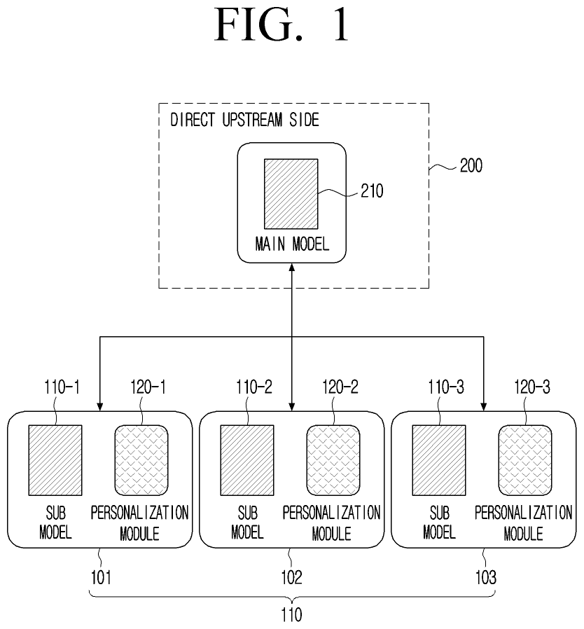

FIG. 1 illustrates a block diagram of a system for preferential advertisement filtering trained over hierarchical distribution according to an embodiment of the disclosure.

Referring to FIG. 1, the system consists of two subsystems: a subscriber-side subsystem 110 and a direct upstream-side subsystem 200. The direct upstream-side subsystem 200 may be implemented in one or more servers, and may hereafter be referred to as server 200. Subscriber-side subsystem 110 collects user preference data through the subscriber-side subsystem's personalization module (120-1, 120-2, 120-3). A user-preference based model is then generated through the subscriber-side subsystem's sub model (110-1, 110-2, 110-3), as well as the personalization module. The user-preference based model is collated and collected by a direct upstream-side main model 210 and fine tunes an aggregated model that is down-streamed to the subscriber-side subsystem as the main model. This process of collating information can be conducted through the following methods including, but not limited to: 1) Federated Learning, 2) Multi-node aggregated training, 3) Ensemble Methods.

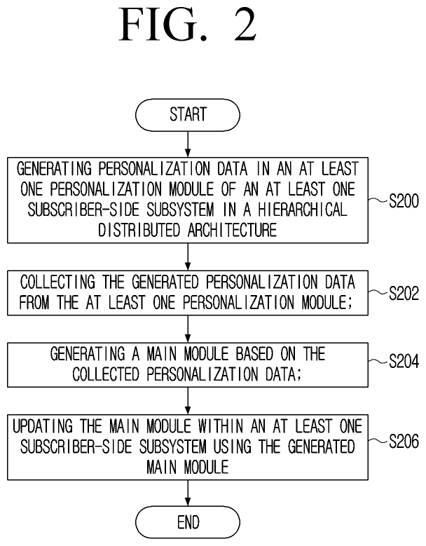

FIG. 2 illustrates a flow chart of a method for preferential advertisement filtering trained over hierarchical distribution according to an embodiment of the disclosure.

Referring to FIG. 2, personalization data is first generated from a subscriber-side subsystem personalization module which is connected in a hierarchal distribution at operation S200. The personalization data constitutes advertisement preferences that are implicitly defined by the user or explicitly defined in the settings. This personalization data is then collected from all the subscriber-side subsystems connected in the same hierarchy and sent to a higher hierarchy at operation S202. Based on the collected personalization data, a main module (or sub model) is generated at operation S204. The system has differential privacy guarantees to ensure user privacy and user data remains within the subscriber-side subsystem. The generated main model (or sub model) is then transmitted back to the subscriber-side subsystem to enable the updating of the advertisement preferences at operation S206. In a preferred embodiment, personalization data can be merged and collated by using model averaging whenever an update trigger is issued.

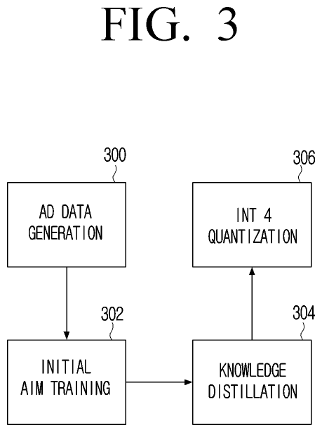

FIG. 3 illustrates a workflow process for generating an AI-based Ad Identifier Model according to an embodiment of the disclosure.

Referring to FIG. 3, the AI-based Ad-identifier Model (AIM) determines whether various network requests and HTML elements are advertisements or not and will be filtered accordingly. The AI-based AIM also serves as a drop-in replacement for classical Regular-Expression-based AIMs. To construct an AI-based AIM a Regular-Expression-based AIM is used to generate an advertisement-identification dataset for training the AI-based AIM at operation 300. The AI-based AIM also uses a pre-trained Large Language Model (LLM)) that understands code as base to fine-tune a teacher model on the advertisement-identification dataset at operation 302. The teacher model then trains a student model via Knowledge Distillation to reduce the size of the AIM at operation 304. The AIM then leverages state-of-the-art techniques in quantization to further reduce the model size to be small enough to deploy to smartphones at operation 306.

In a preferred embodiment of the disclosure, the ground-truth identifier or the ad-identification dataset can be Samsung Internet as it supports regex-based AIM. The dataset is generated by loading Alexa 10K (top 10,000 websites commonly used) using public filter rules. In the dataset generation process, network requests can be logged using Network Inspector dumps, or webRequest API queries. Also, HTML/CSS rules applied to DOM elements can be queried via the document Web APIs.

To be able to fine-tune the AI based AIM using the generated ad-identification dataset, CodeGen, a 16B parameter transformer LLM pre-trained on source code, is used as the initialization point. While the AIM performs strongly on ad-identification, it is too large to deploy to a phone. To reduce the size, a smaller student AIM is trained via Knowledge Distillation with the trained AIM as the teacher. A residual-guided distillation is used to create an encoder-only student AIM with 55M parameters (290× reduction) with a total size of ˜260 MB (32-bit floating point).

To further reduce the size of the model and optimize inference latency on-device, INT4 Quantization is used. By compressing the model to use 4 bit weights and activations, the size of the model is further reduced down to ˜32 MB (4-bit integer compression). This model now acts as a drop-in replacement for regex-based AIMs of comparable size.

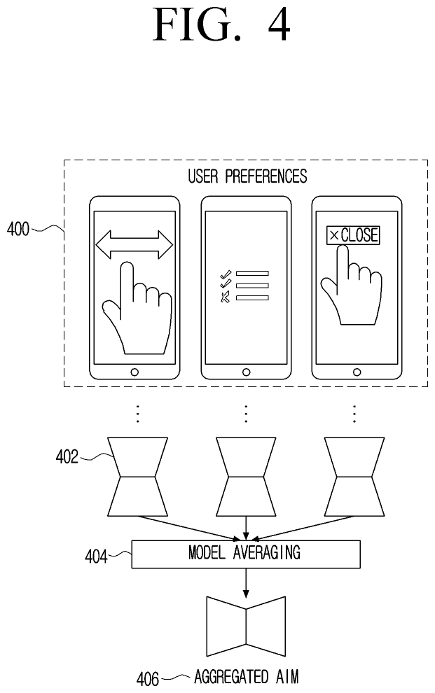

FIG. 4 illustrates a workflow process for user personalization according to an embodiment of the disclosure.

Referring to FIG. 4, to enable this feature, the subscriber-side subsystem collects user ad preference as training data for further fine-tuning at operation 400. However, the data never leaves the user's device to ensure privacy. Adapters on-device are then used to learn preferences through the collected user data at operation 402. This is made possible through the extensive model compression done. Furthermore, the system has differential privacy guarantees to ensure user privacy. Since user preferences differ for each device, model averaging is employed to merge learned adapters into the original AIM when an update trigger is issued at operation 404 to generate a new aggregated AIM at operation 406 that will replace the original AIM.

In a preferred embodiment, the user can initiate their own ad blocking behavior, on top of the existing AI-based AIM. This can be done through user gestures, such as swiping, which can be detected by the Browser Adblocker API. The Adblocker API will generate respective labeled data and the browser can observe via document web API and send it to the AIM. This collected data is counted as user ad preference but will not leave the user's phone to ensure privacy.

In another preferred embodiment, the system can correct false positives by the AIM that break the site flow to preserve site functionality. Included in this are also site-specific content that a specific user may want to see. In this embodiment, the user can disable the AIM temporarily and reload the website. The AIM takes note of the ads that are now “unblocked” and adds new training data. The user can re-block ads, adding further training data to fine-tune the AIM. On user revisit, the site is not broken but any ads marked by the user are still hidden.

In another preferred embodiment, the system makes use of LoRA to learn the personalization preference of a user. In particular, INT4 AIM is terminated and low-rank decomposition matrices in the multi-head-attention layers are injected, and then the adapter is trained using the stored user data. This outputs an adapter that can be attached to the on-device AIM and alters its behavior such that future ad-blocking on a user's device will match the individual user's preferences. As the model is quantized to be small enough, all training happens on-device. In addition, a Differentially-Private-Stochastic Gradient Descent (DP-SGD) algorithm is used to guarantee differential privacy on the output adapter.

In an embodiment, when a majority of users report a preference for the same ad, learned knowledge of their personal adapters can be merged to automatically update the original AIM. An update trigger can be defined to happen whenever a certain threshold (e.g., 90%) of users report the same preference for an ad that was not part of the training data for the original Teacher AIM. To detect this trigger, a differentially private database of user ad preference is maintained.

It is also possible to use the adapter's decomposition matrices as proxies for a user's preferences since the adapter has learned these on device. A method for comparing the distance between user adapters and the original AIM in vector space may be used as an alternative trigger for updating, but this requires further research. Note that this method does not require additional privacy measures as the adapters are differentially private by default, which guarantees the privacy of a vector metric-based update trigger.

One advantage of using LoRA is that the adapter (which are decomposition matrices) can be merged into the weights of the model itself. Thus, when an update trigger is issued, all the users' personal adapters are pulled from their devices, Soup-style Model Averaging is performed, and the averaged adapter is merged into the original AIM. The base AIM is then updated in every user's phone with the new one. Since every user's adapter makes use of DP-SGD, this entire automatic update process is guaranteed to be differentially private.

In another embodiment, the disclosure can have a multi-level hierarchy which employs region-specific modules and adapters for certain regions and subscribers under that region, similar to how advertising networks enforce regional rules on advertisement-filtering. Similar to how a user can personalize his own ad-filtering, a region administrator can also manually label if certain elements are ads or not or implicitly obtain information from its downstream subscribers. This can then either be used to additionally filter content or update the main model, depending on geographic-specific restrictions and personalization.

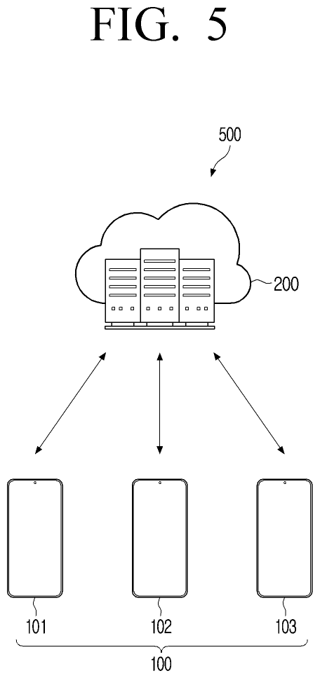

FIG. 5 illustrates a system for performing an advertisement blocking according to an embodiment of the disclosure.

Referring to FIG. 5, a system 500 may include the electronic apparatus 100 and the server 200.

The electronic apparatus 100 may indicate at least one apparatus of the subsystem. The electronic apparatus 100 may include at least one of a first electronic apparatus 101, a second electronic apparatus 102 or a third electronic apparatus 103. The electronic apparatus 100 may be a terminal apparatus. For example, the electronic apparatus 100 is a smart-phone, a tablet or a personal device including display module. The electronic apparatus 100 may be described as a display apparatus. The electronic apparatus 100 may perform a function of advertisement blocking. The electronic apparatus 100 may store an artificial intelligence model for performing the function of advertisement blocking.

The server 200 may manage the electronic apparatus 100. The server 200 may communicate the electronic apparatus 100. For example, the server 200 indicates a cloud server. The server 200 may provide the artificial intelligence model for performing the function of advertisement blocking.

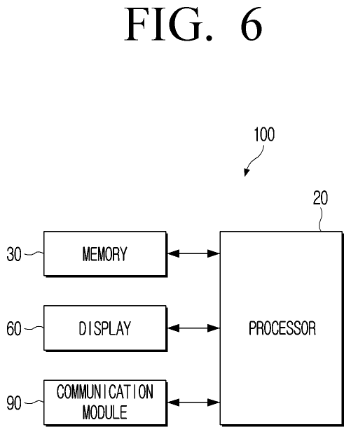

FIG. 6 is a block diagram illustrating an electronic apparatus according to an embodiment of the disclosure.

Referring to FIG. 6, an electronic apparatus 100 comprises memory 30 configured to store a first sub model corresponding to a main model, wherein the main model is stored in a server 200, and wherein the first sub model is obtained by reducing a size of the main model, a communication module 90 configured to communicate with the server 200 including the main model, a display 60 and at least one processor 20 configured to control the display 60 to display a first screen including an advertisement, obtain a first user input for blocking the advertisement, obtain a second screen without the advertisement as inputting the first screen and the first user input into the first sub model, control the display 60 to display the second screen without the advertisement, based on a first pre-determined event being identified, obtain first user data including the first user input, the first screen and the second screen, and obtain a second sub model by re-training the first sub model based on the first user data.

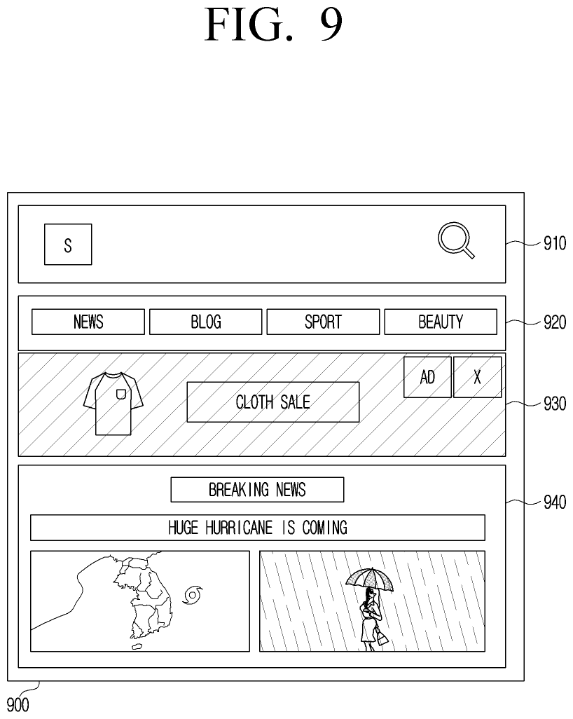

The first screen may be a screen related to a web browser or an execution screen of application. The first screen may include an advertisement. The first screen may be described as a screen 900 of FIG. 9.

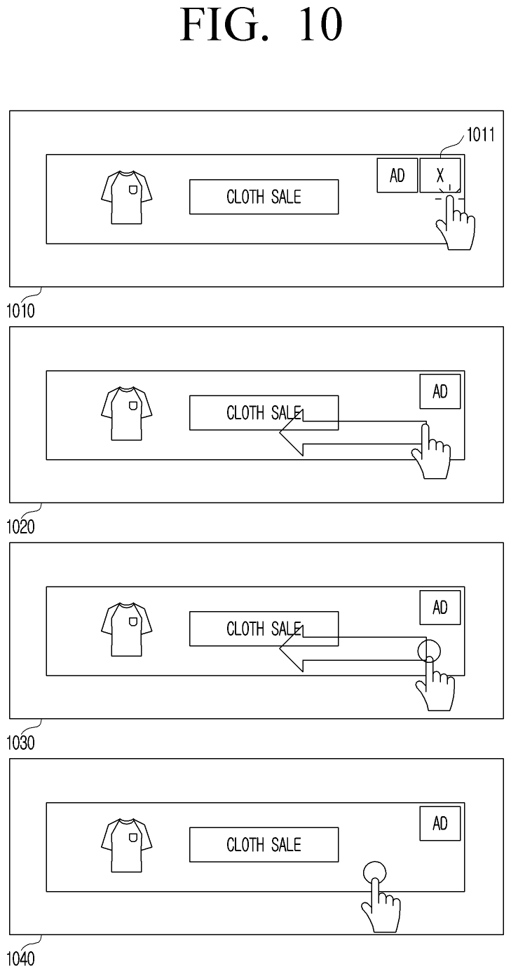

The first user input may be blocking behavior of a user, related to the advertisement. The user is a user of the electronic apparatus 100. The first user input may be described in FIG. 10.

Based on the first user input received through the advertisement included in the first screen, the at least one processor 20 may input the first screen and the first user input into the first sub model. The first user input may refer to indicate that the user wants to block the advertisement in the first screen. The first user input may include a specific position information on the first screen.

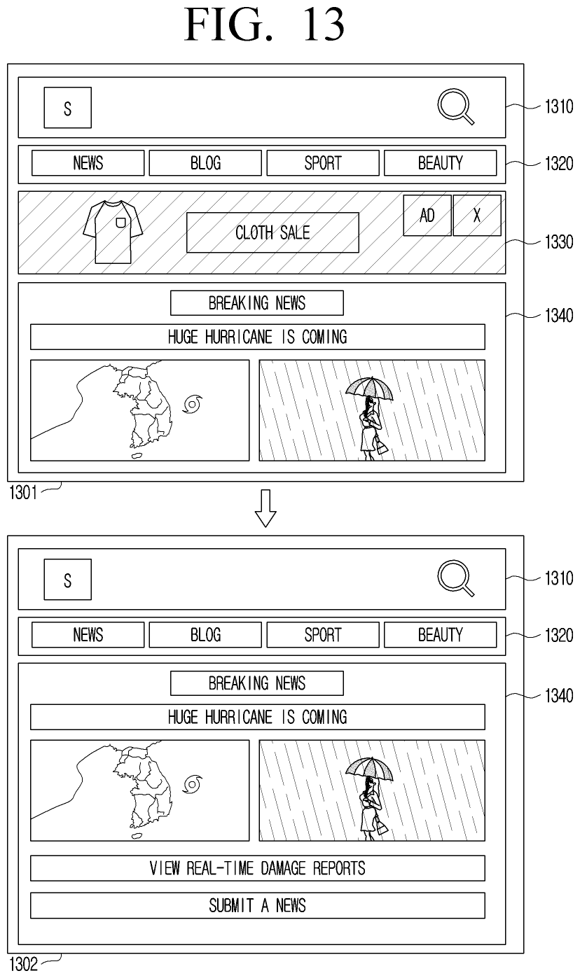

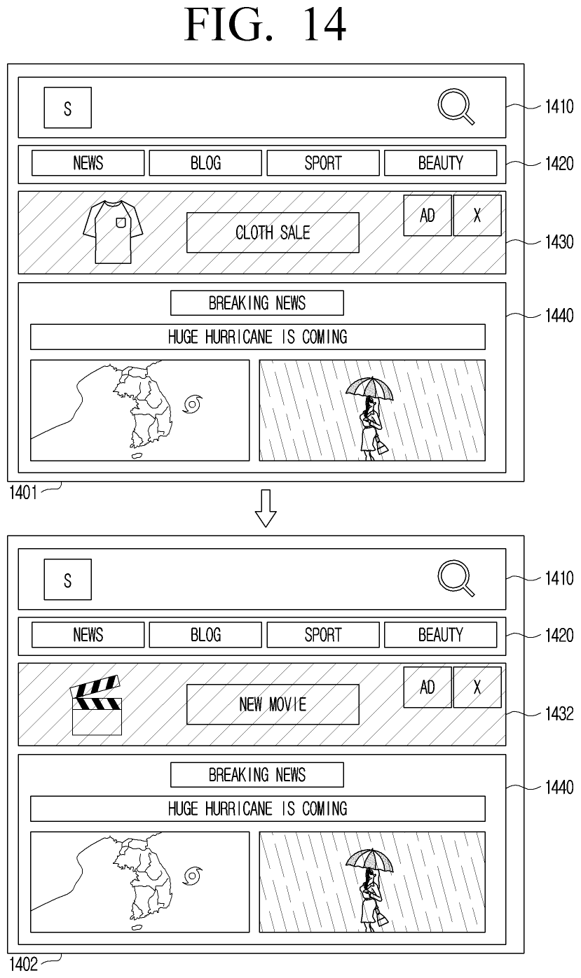

The at least one processor 20 may obtain the second screen as output data of the first sub model. The second screen may not include the advertisement. The second screen may be changed from the first screen. The second screen may be described as new screen without the advertisement. The second screen may be described as a screen 1302 of FIG. 13 or a screen 1402 of FIG. 14.

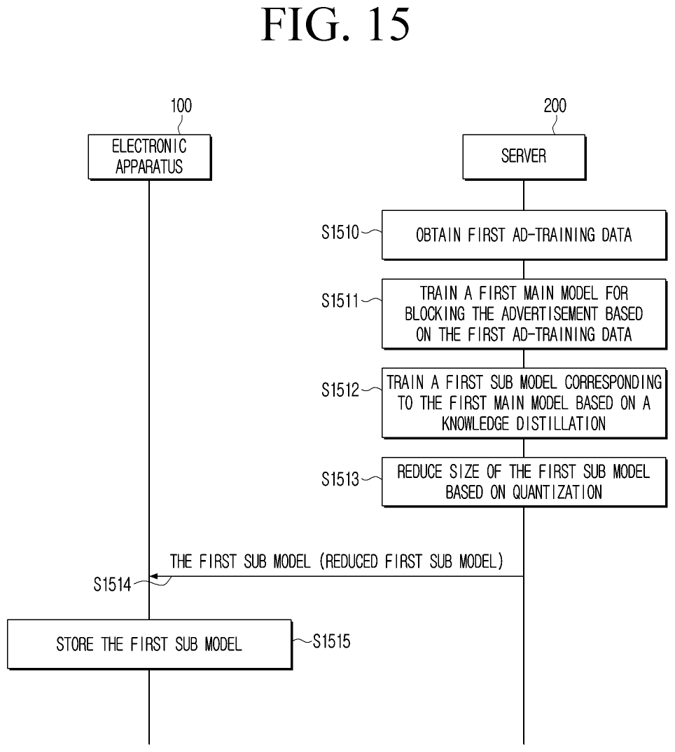

The main model may be obtained by training on the server 200. The first sub model may be obtained by training the main model, on the server 200, based on at least one of Knowledge Distillation or Quantization. The main model may be described in FIG. 15.

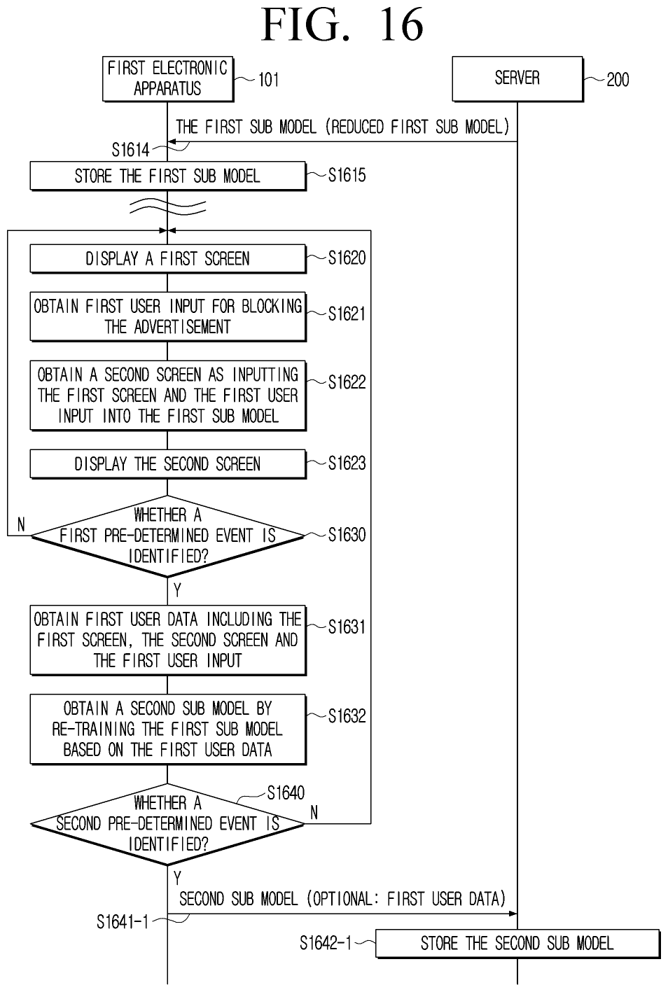

The at least one processor 20 may, through the communication module 90, receive the first sub model from the server 200, and store the first sub model in the memory 30. The storing operation may be described in FIG. 16.

The at least one processor 20 may obtain the second screen by performing a function for blocking an advertisement through the first sub model. The function may be described as a blocking function, an advertisement blocking function or removing advertisement function.

The first pre-determined event may include an event for executing a training mode related to the function for blocking the advertisement of the sub model.

Based on a second pre-determined event being identified, the at least one processor 20 may, through the communication module 90, transmit the second sub model to the server 200.

The second pre-determined event may include an event indicating that a pre-determined period has elapsed.

The first pre-determined event and the second pre-determined event may be described in FIG. 16.

The first sub model may be stored in another electronic apparatus 102. The server 200 may receive a third sub model from the other electronic apparatus 102. The third sub model may be obtained by re-training the first sub model based second user data of the other electronic apparatus 102.

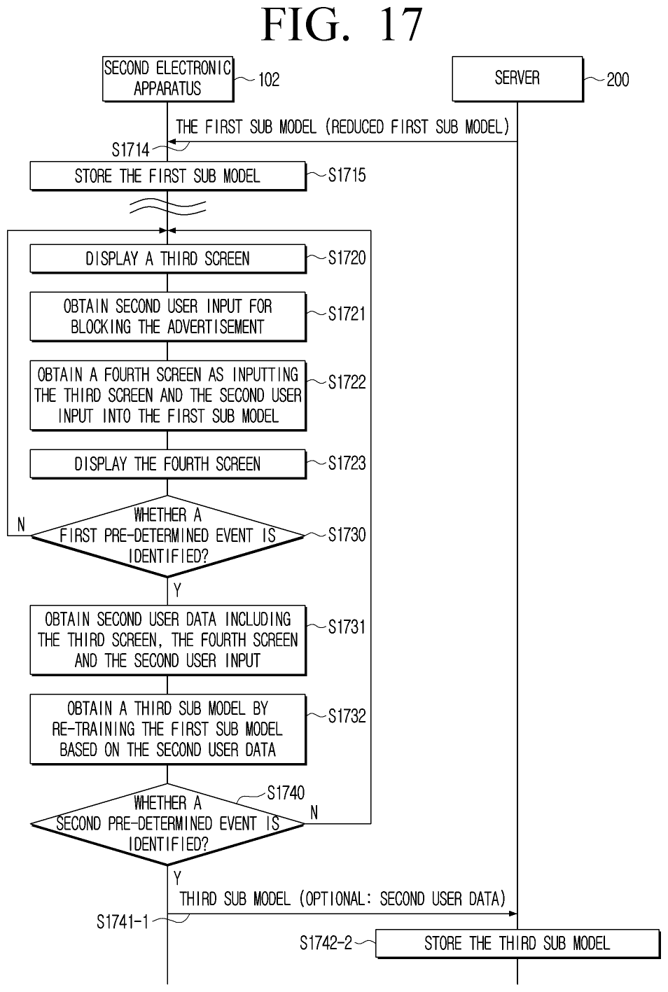

The other electronic apparatus 102 may be described in FIG. 17. The electronic apparatus 100 may be described as an electronic apparatus 101.

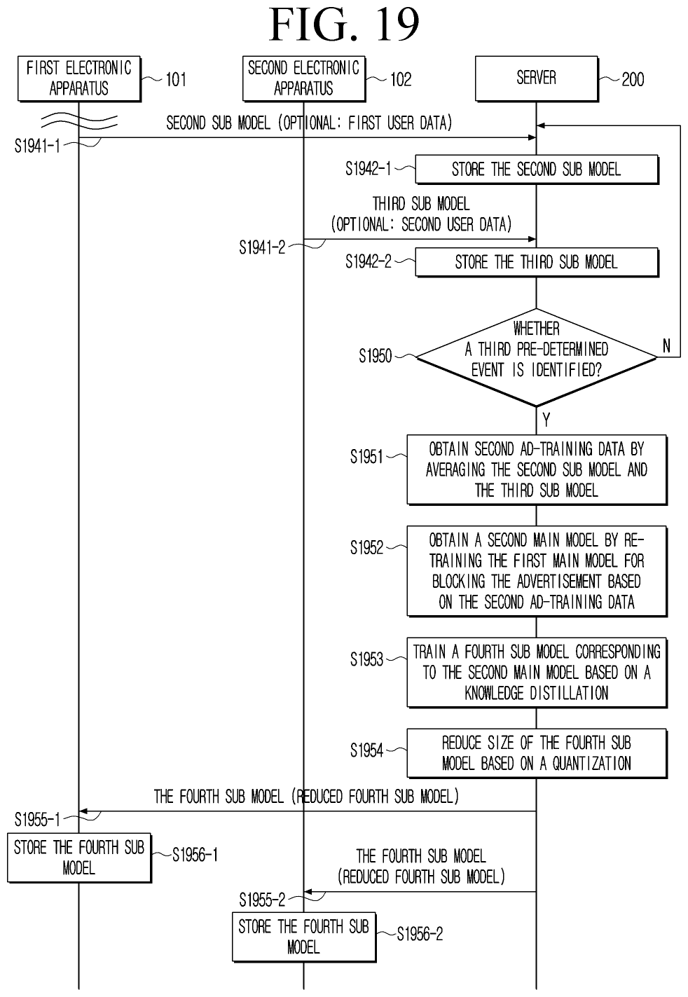

The at least one processor 20 may, through the communication module 90, receive a fourth sub model from the server 200, store the fourth sub model in the memory 30. The main model is a first main model. The fourth sub model may be obtained by re-training a second main model, on the server 200, based on at least one of Knowledge Distillation or Quantization. The second main model may be obtained by re-training the first main model, on the server 200, based on the second sub model and the third sub model. The fourth sub model may be described in FIG. 19.

The at least one processor 20 may obtain a HTML element and a network element based on the first screen, and obtain the second screen without the advertisement as inputting the HTML element, the network element and the first user input into the first sub model.

The at least one processor 20 may communicate a provider for providing the first screen. The at least one processor 20 may the HTML element. The HTML element may be included in a HTML document. The at least one processor 20 may receive the HTML document from the provider. The provider may be described as external apparatus.

The at least one processor 20 may obtain the HTML element based on the HTML document. The at least one processor 20 may obtain a HTML document based on a first screen. The HTML document may include information for displaying the first screen. The at least one processor 20 may identify position of the advertisement based on the HTML element.

The at least one processor 20 may obtain the network element based on a network log data. The at least one processor 20 may collect the network log data between the electronic apparatus 100 and the provider for providing the first screen. The at least one processor 20 may collect the network log data related to the first screen. The network log data may include information indicating receiving user input for blocking the advertisement (e.g. first user input). The at least one processor 20 may identify the first user input based on the network element.

The system including the main model and the sub model may be integrated as part of specific internet network or specific web browsers.

The system may provide applicable in region-wide servers as content filtering services.

The system may provide any advertisement filtering system which consists of self-improving advertisement filtering based on parameters on the user level

The system may provide method of region-based content filtering based on region specific restrictions or personalization.

As for technical detectability, a simulation and test on multiple devices may be executed to check for an ad personalization system in play based on region or user preference.

The system may reduce dependence on third party services. The system may reduce operating costs and related expenses.

The system may collect automated response against unwanted ads.

The system may provide the easier personalization of ads while maintaining privacy policy. The system may reduce concerns from both users and website hosts.

As the data is trained on device, the data does not leave the device, and the system is differentially private, the system is compliant with international data privacy laws.

The system may improve personalization of advertisements by training a model locally based on user preferences. When it comes to updating the model upstream, privacy is maintained by training local model using DP-SGD and adapters.

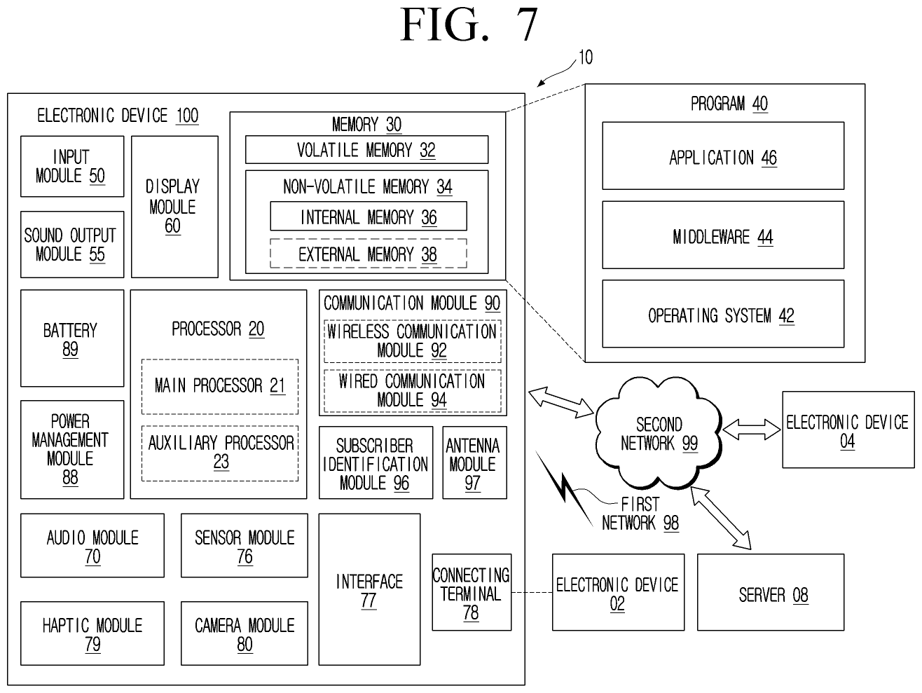

FIG. 7 is a block diagram illustrating an electronic apparatus in a network environment according to an embodiment of the disclosure.

Referring to FIG. 7, the electronic apparatus 100 in the network environment 10 may communicate with an electronic device 02 via a first network 98 (e.g., a short-range wireless communication network), or at least one of an electronic device 04 or a server 08 via a second network 99 (e.g., a long-range wireless communication network). According to an embodiment, the electronic apparatus 100 may communicate with the electronic device 04 via the server 08. According to an embodiment, the electronic apparatus 100 may include a processor 20, memory 30, an input module 50, a sound output module 55, a display 60, an audio module 70, a sensor module 76, an interface 77, a connecting terminal 78, a haptic module 79, a camera module 80, a power management module 88, a battery 89, a communication module 90, a subscriber identification module (SIM) 96, or an antenna module 97. In some embodiments, at least one of the components (e.g., the connecting terminal 78) may be omitted from the electronic apparatus 100, or one or more other components may be added in the electronic apparatus 100. In some embodiments, some of the components (e.g., the sensor module 76, the camera module 80, or the antenna module 97) may be implemented as a single component (e.g., the display 60).

The processor 20 executes, for example, software (e.g., a program 40) to control at least one other component (e.g., a hardware or software component) of the electronic apparatus 100 coupled with the processor 20, and may perform various data processing or computation. According to one embodiment, as at least part of the data processing or computation, the processor 20 may store a command or data received from another component (e.g., the sensor module 76 or the communication module 90) in volatile memory 32, process the command or the data stored in the volatile memory 32, and store resulting data in non-volatile memory 34. According to an embodiment, the processor 20 may include a main processor 21 (e.g., a central processing unit (CPU) or an application processor (AP)), or an auxiliary processor 23 (e.g., a graphics processing unit (GPU), a neural processing unit (NPU), an image signal processor (ISP), a sensor hub processor, or a communication processor (CP)) that is operable independently from, or in conjunction with, the main processor 21. For example, when the electronic apparatus 100 includes the main processor 21 and the auxiliary processor 23, the auxiliary processor 23 is adapted to consume less power than the main processor 21, or to be specific to a specified function. The auxiliary processor 23 may be implemented as separate from, or as part of the main processor 21.

The auxiliary processor 23 may control at least some of functions or states related to at least one component (e.g., the display 60, the sensor module 76, or the communication module 90) among the components of the electronic apparatus 100, instead of the main processor 21 while the main processor 21 is in an inactive (e.g., sleep) state, or together with the main processor 21 while the main processor 21 is in an active state (e.g., executing an application). According to an embodiment, the auxiliary processor 23 (e.g., an image signal processor or a communication processor) may be implemented as part of another component (e.g., the camera module 80 or the communication module 90) functionally related to the auxiliary processor 23. According to an embodiment, the auxiliary processor 23 (e.g., the neural processing unit) may include a hardware structure specified for artificial intelligence model processing. An artificial intelligence model may be generated by machine learning. Such learning may be performed, e.g., by the electronic apparatus 100 where the artificial intelligence is performed or via a separate server (e.g., the server 08). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 30 may store various data used by at least one component (e.g., the processor 20 or the sensor module 76) of the electronic apparatus 100. The various data may include, for example, software (e.g., the program 40) and input data or output data for a command related thereto. The memory 30 may include the volatile memory 32 or the non-volatile memory 34.

The program 40 may be stored in the memory 30 as software, and includes, for example, an operating system (OS) 42, middleware 44, or an application 46.

The input module 50 may receive a command or data to be used by another component (e.g., the processor 20) of the electronic apparatus 100, from the outside (e.g., a user) of the electronic apparatus 100. The input module 50 includes, for example, a microphone, a mouse, a keyboard, a key (e.g., a button), or a digital pen (e.g., a stylus pen).

The sound output module 55 may output sound signals to the outside of the electronic apparatus 100. The sound output module 55 includes, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display 60 may visually provide information to the outside (e.g., a user) of the electronic apparatus 100. The display 60 includes, for example, a display, a hologram device, or a projector and control circuitry to control a corresponding one of the display, hologram device, and projector. According to an embodiment, the display 60 may include a touch sensor adapted to detect a touch, or a pressure sensor adapted to measure the intensity of force incurred by the touch.

The audio module 70 may convert a sound into an electrical signal and vice versa. According to an embodiment, the audio module 70 may obtain the sound via the input module 50, or output the sound via the sound output module 55 or a headphone of an external electronic device (e.g., an electronic device 02) directly (e.g., wiredly) or wirelessly coupled with the electronic apparatus 100.

The sensor module 76 may detect an operational state (e.g., power or temperature) of the electronic apparatus 100 or an environmental state (e.g., a state of a user) external to the electronic apparatus 100, and then generate an electrical signal or data value corresponding to the detected state. According to an embodiment, the sensor module 76 includes, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 77 may support one or more specified protocols to be used for the electronic apparatus 100 to be coupled with the external electronic device (e.g., the electronic device 02) directly (e.g., wiredly) or wirelessly. According to an embodiment, the interface 77 includes, for example, a high definition multimedia interface (HDMI), a universal serial bus (USB) interface, a secure digital (SD) card interface, or an audio interface.

A connecting terminal 78 may include a connector via which the electronic apparatus 100 may be physically connected with the external electronic device (e.g., the electronic device 02). According to an embodiment, the connecting terminal 78 includes, for example, an HDMI connector, a USB connector, an SD card connector, or an audio connector (e.g., a headphone connector).

The haptic module 79 may convert an electrical signal into a mechanical stimulus (e.g., a vibration or a movement) or electrical stimulus which may be recognized by a user via his tactile sensation or kinesthetic sensation. According to an embodiment, the haptic module 79 includes, for example, a motor, a piezoelectric element, or an electric stimulator.

The camera module 80 may capture a still image or moving images. According to an embodiment, the camera module 80 may include one or more lenses, image sensors, image signal processors, or flashes.

The power management module 88 may manage power supplied to the electronic apparatus 100. According to one embodiment, the power management module 88 is implemented as at least part of, for example, a power management integrated circuit (PMIC).

The battery 89 may supply power to at least one component of the electronic apparatus 100. According to an embodiment, the battery 89 includes, for example, a primary cell which is not rechargeable, a secondary cell which is rechargeable, or a fuel cell.

The communication module 90 may support establishing a direct (e.g., wired) communication channel or a wireless communication channel between the electronic apparatus 100 and the external electronic device (e.g., the electronic device 02, the electronic device 04, or the server 08) and performing communication via the established communication channel. The communication module 90 may include one or more communication processors that are operable independently from the processor 20 (e.g., the application processor (AP)) and supports a direct (e.g., wired) communication or a wireless communication. According to an embodiment, the communication module 90 may include a wireless communication module 92 (e.g., a cellular communication module, a short-range wireless communication module, or a global navigation satellite system (GNSS) communication module) or a wired communication module 94 (e.g., a local area network (LAN) communication module or a power line communication (PLC) module). A corresponding one of these communication modules may communicate with the external electronic device via the first network 98 (e.g., a short-range communication network, such as Bluetooth™ wireless-fidelity (Wi-Fi) direct, or infrared data association (IrDA)) or the second network 99 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 92 may identify and authenticate the electronic apparatus 100 in a communication network, such as the first network 98 or the second network 99, using subscriber information (e.g., international mobile subscriber identity (IMSI)) stored in the subscriber identification module 96.

The wireless communication module 92 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 92 may support a high-frequency band (e.g., the millimeter wave (mmWave) band) to achieve, e.g., a high data transmission rate. The wireless communication module 92 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 92 may support various requirements specified in the electronic apparatus 100, an external electronic device (e.g., the electronic device 04), or a network system (e.g., the second network 99). According to an embodiment, the wireless communication module 92 may support a peak data rate (e.g., 20 Gbps or more) for implementing eMBB, loss coverage (e.g., 64 dB or less) for implementing mMTC, or U-plane latency (e.g., 0.5 ms or less for each of downlink (DL) and uplink (UL), or a round trip of ms or less) for implementing URLLC.

The antenna module 97 may transmit or receive a signal or power to or from the outside (e.g., the external electronic device) of the electronic apparatus 100. According to an embodiment, the antenna module 97 may include an antenna including a radiating element composed of a conductive material or a conductive pattern formed in or on a substrate (e.g., a printed circuit board (PCB)). According to an embodiment, the antenna module 97 may include a plurality of antennas (e.g., array antennas). In such a case, at least one antenna appropriate for a communication scheme used in the communication network, such as the first network 98 or the second network 99, is selected, for example, by the communication module 90 (e.g., the wireless communication module 92) from the plurality of antennas. The signal or the power may then be transmitted or received between the communication module 90 and the external electronic device via the selected at least one antenna. According to an embodiment, another component (e.g., a radio frequency integrated circuit (RFIC)) other than the radiating element may be additionally formed as part of the antenna module 97.

According to various embodiments, the antenna module 97 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic apparatus 100 and the external electronic device 04 via the server 08 coupled with the second network 99. Each of the electronic devices 02 or 04 may be a device of a same type as, or a different type, from the electronic apparatus 100. According to an embodiment, all or some of operations to be executed at the electronic apparatus 100 may be executed at one or more of the external electronic devices 02, 04, or 08. For example, if the electronic apparatus 100 should perform a function or a service automatically, or in response to a request from a user or another device, the electronic apparatus 100, instead of, or in addition to, executing the function or the service, requests the one or more external electronic devices to perform at least part of the function or the service. The one or more external electronic devices receiving the request may perform the at least part of the function or the service requested, or an additional function or an additional service related to the request, and transfer an outcome of the performing to the electronic apparatus 100. The electronic apparatus 100 may provide the outcome, with or without further processing of the outcome, as at least part of a reply to the request. To that end, a cloud computing, distributed computing, mobile edge computing (MEC), or client-server computing technology may be used, for example. The electronic apparatus 100 may provide ultra low-latency services using, e.g., distributed computing or mobile edge computing. In another embodiment, the external electronic device 04 may include an internet-of-things (IoT) device. The server 08 may be an intelligent server using machine learning and/or a neural network. According to an embodiment, the external electronic device 04 or the server 08 may be included in the second network 99. The electronic apparatus 100 may be applied to intelligent services (e.g., smart home, smart city, smart car, or healthcare) based on 5G communication technology or IoT-related technology.

The electronic device according to various embodiments may be one of various types of electronic devices. The electronic devices includes, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module is implemented in a form of an application-specific integrated circuit (ASIC).

Various embodiments as set forth herein may be implemented as software (e.g., the program 40) including one or more instructions that are stored in a storage medium (e.g., internal memory 36 or external memory 38) that is readable by a machine (e.g., the electronic apparatus 100). For example, a processor (e.g., the processor 20) of the machine (e.g., the electronic apparatus 100) invokes at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

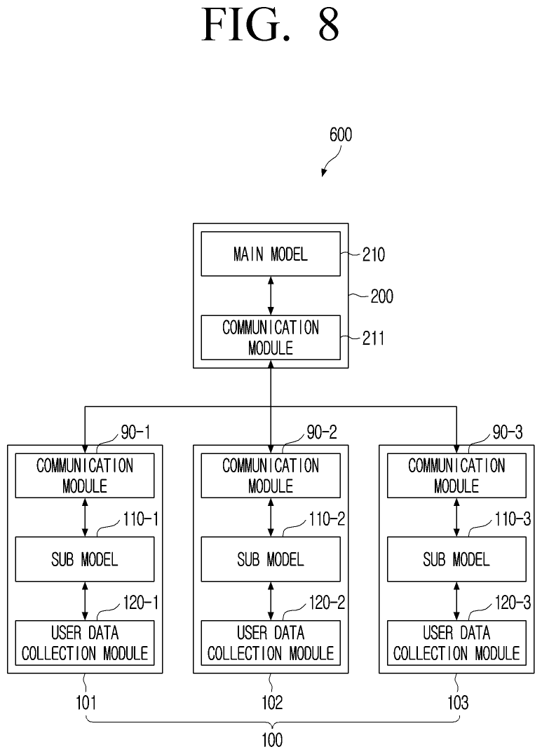

FIG. 8 illustrates a system for performing an advertisement blocking according to an embodiment of the disclosure.

Referring to FIG. 8, a system 600 may include the electronic apparatus 100 and the server 200. The system 600 may corresponds to the system 500 in FIG. 5.

The electronic apparatus 100 may include at least one of first electronic apparatus 101, second electronic apparatus 102 or third electronic apparatus 103. The electronic apparatus 100 may include a communication module.

The first electronic apparatus 101 may include a communication module 90-1. The first electronic apparatus 101 may communicate the server 200 through the communication module 90-1.

The second electronic apparatus 102 may include a communication module 90-2. The second electronic apparatus 102 may communicate the server 200 through the communication module 90-2.

The third electronic apparatus 103 may include a communication module 90-3. The third electronic apparatus 103 may communicate the server 200 through the communication module 90-3.

The electronic apparatus 100 may include a sub model and a user data collection module.

The sub model may indicate the artificial intelligence model for performing the function of advertisement blocking in FIG. 5.

The user data collection module indicate the personalization module 120-1, 120-2, 120-3 in FIG. 1. The user data collection module may obtain data related to a user of the electronic apparatus 100. The user data collection module may obtain the data related with behavior of the user of the electronic apparatus 100.

The first electronic apparatus 101 may include a sub model 110-1 and user data collection module 120-1. The user data collection module 120-1 may obtain user data through the user data collection module 120-1. The user data collection module 120-1 may transmit the user data to the sub model 110-1. The first electronic apparatus 101 may train the sub model 110-1 based on the user data transmitted the user data collection module 120-1. The first electronic apparatus 101 may obtain the trained sub model. The trained sub model may be described as the updated sub model. The first electronic apparatus 101 may transmit the trained sub model to the server 200 through the communication module 90-1. The server 200 may receive the trained sub model of the first electronic apparatus 101 through the communication module 211. The server 200 may train the main model 210 based on the received sub model of the first electronic apparatus 101.

The second electronic apparatus 102 may include a sub model 110-2 and user data collection module 120-2. The user data collection module 120-2 may obtain user data through the user data collection module 120-2. The user data collection module 120-2 may transmit the user data to the sub model 110-2. The second electronic apparatus 102 may train the sub model 110-2 based on the user data transmitted the user data collection module 120-2. The second electronic apparatus 102 may obtain the trained sub model. The trained sub model may be described as the updated sub model. The second electronic apparatus 102 may transmit the trained sub model to the server 200 through the communication module 90-2. The server 200 may receive the trained sub model of the second electronic apparatus 102 through the communication module 211. The server 200 may train the main model 210 based on the received sub model of the second electronic apparatus 102.

The third electronic apparatus 103 may include a sub model 110-3 and user data collection module 120-3. The user data collection module 120-3 may obtain user data through the user data collection module 120-3. The user data collection module 120-3 may transmit the user data to the sub model 110-3. The third electronic apparatus 103 may train the sub model 110-3 based on the user data transmitted the user data collection module 120-3. The third electronic apparatus 103 may obtain the trained sub model. The trained sub model may be described as the updated sub model. The third electronic apparatus 103 may transmit the trained sub model to the server 200 through the communication module 90-3. The server 200 may receive the trained sub model of the third electronic apparatus 103 through the communication module 211. The server 200 may train the main model 210 based on the received sub model of the third electronic apparatus 103.

According to various embodiments, the user data collection module (120-1, 120-2, 120-3) may connect the communication module (90-1, 90-2, 90-3) of the electronic apparatus (101, 102, 103). The user data collection module (120-1, 120-2, 120-3) may transmit the user data to the server 200. The server 200 may receive the user data of the electronic apparatus 100 through the communication module 211. The server 200 may train the main model 210 based on the received user data of the electronic apparatus 100.

The server 200 may be described as direct upstream side. The main model 210 may be described as Advertisement Identifier Model (AIM). The sub model 110-1, 110-2, 110-3 may be described as adapter.

The system 600 may determine whether various network requests and HTML elements are advertisements or not and will be filtered accordingly.

The system 600 may allow for users to manually label on-screen elements to specify if they are legitimate advertisements or not. The personalization may be used for automatically updating the main model 210.

Raw data (e.g. user data) may not leave the electronic apparatus (101, 102, 103) and training makes use of differentially private techniques which ensures user privacy at all times. The system 600 may allow for Personalization and Automatic Updating through the adapter-based training.

The main model 210 may perform operations. The main model 210 may perform an advertisement data generation. The main model 210 may use classic Regular-Expression-based AIMs to generate an Advertisement-Identification dataset to train Neural-Network-based AIM.

The main model 210 may perform a Teacher Model Training. The main model 210 may use a pre-trained Large Language Model (LLM) that understands code. The main model 210 may fine-tune a teacher model on our Advertisement-Identification dataset.

For example, the main model 210 fine-tunes a strong AIM using advertisement Identification dataset. The main model may use a 16B parameter Transformer LLM pre-trained on source code, as the initialization point.

The main model 210 may perform a Knowledge Distillation. The main model 210 may use the teacher model to train a student model via Knowledge Distillation to reduce the size of the AIM (e.g. 290× reduction in size)

To reduce the size of the main model 210, the main model 210 may train a smaller Student AIM via Knowledge Distillation, with the trained AIM as the teacher.

For example, the server 200 uses residual-guided distillation to create an encoder-only Student AIM with 55M parameters (290× reduction) with a total size of ˜260 MB (32-bit floating point).

The main model 210 may perform a INT4 Quantization. The main model 210 may reduce the sub model's size to be small enough to deploy to user device (e.g. smartphone).

For example, the main model 210 uses INT4 Quantization to further reduce the size of the model and optimize inference latency on-device.

By compressing the model to use 4 bit weights and activations, we further reduce the size of the model down to ˜32 MB (4-bit integer compression). This model now acts as a drop-in replacement for Regex-based AIMs of comparable size.

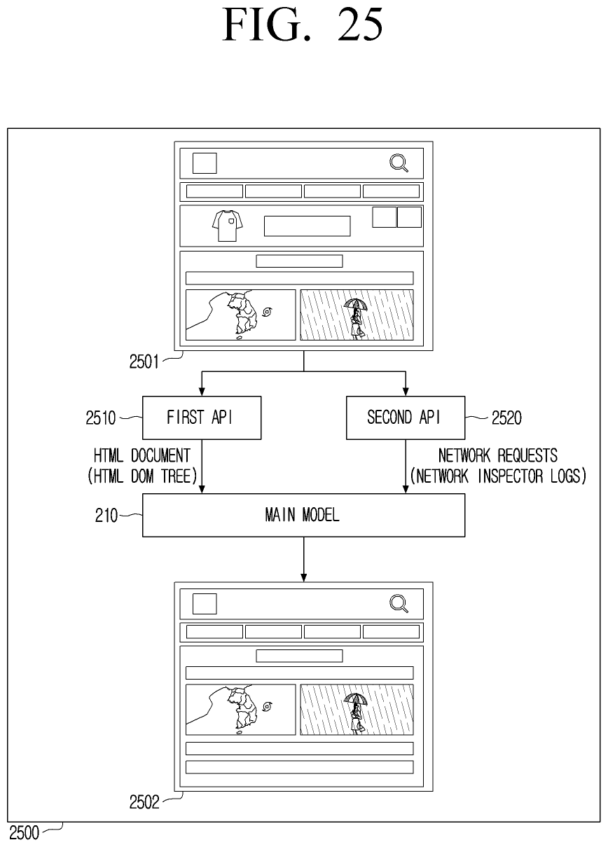

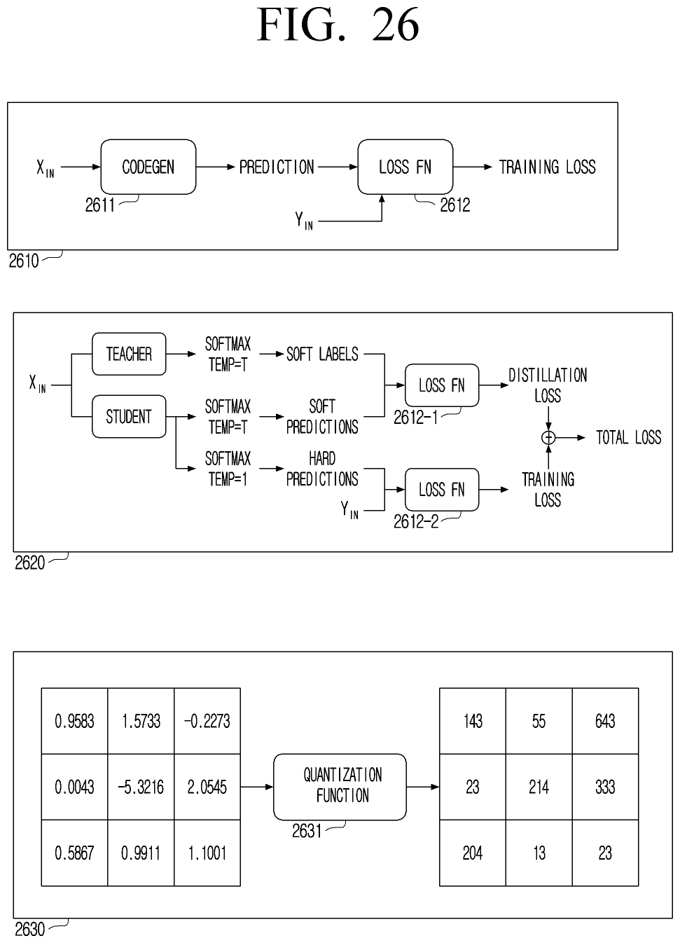

Detailed description of the main model 210 is described in FIGS. 25 and 26.

The sub model 110-1, 110-2, 110-3 may perform user data collection. User advertisement preference may be collected as training data for further fine-tuning. The user data is only stored in the electronic apparatus 100.

The electronic apparatus 100 may receive a user input for blocking the advertisement which is displayed on the electronic apparatus 100. The electronic apparatus 100 may perform the function for blocking the advertisement by using the sub model 110-1, 110-2, 110-3.

The user input may be described as user gesture. The gesture is described in FIG. 10. The user input may be detected by the Browser Adblocker Application Programming Interface (API). The Adblocker API may generate respective collected data. The Browser Adblocker API may observe via document web API. The Browser Adblocker API may send the collected data to the main model 210 of the server 200. The collected data is counted as user advertisement preference on the electronic apparatus 100.

The electronic apparatus 100 may preserve site functionality. The electronic apparatus 100 may correct false positives by the sub model 110-1, 110-2, 110-3 that break the site flow. The electronic apparatus 100 may transmit a command for disabling the sub model 110-1, 110-2, 110-3 temporarily and reloading website, to the server 200.

The sub model 110-1, 110-2, 110-3 may obtain a screen including unblocked advertisement and a screen without advertisement as training data.

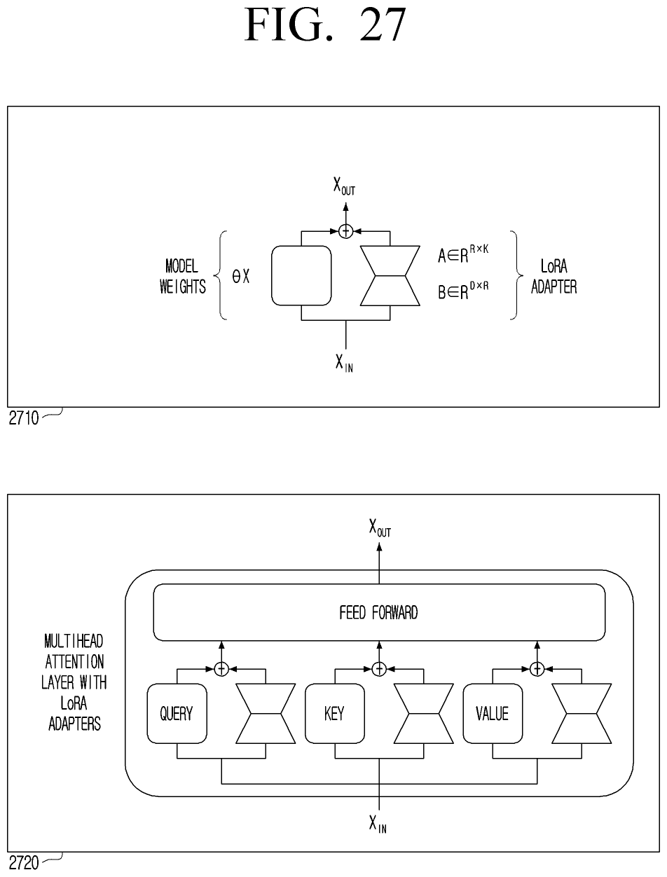

The sub model 110-1, 110-2, 110-3 may perform Adapter Training. The sub model 110-1, 110-2, 110-3 may use adapters to learn preferences using the collected user data. This process may be occurred on-device, made possible through extensive model compression. The training process may use Differential Privacy to ensure user privacy. The Adapter Training may be described in FIG. 27.

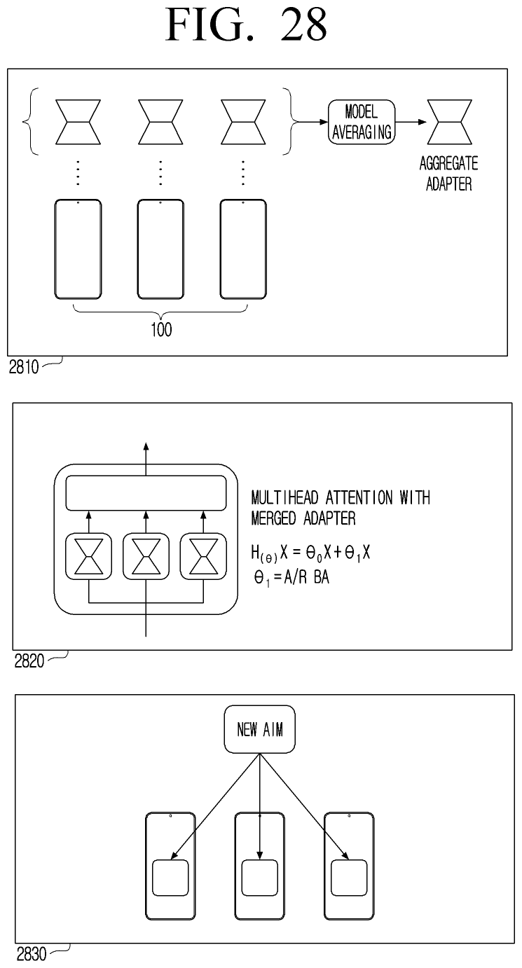

The sub model 110-1, 110-2, 110-3 may perform Automatically Updating the AIM. The sub model 110-1, 110-2, 110-3 may use model averaging to merge learned adapters into the original AIM when an update trigger is issued. The updating operation may be described in FIG. 28.

FIG. 9 illustrates a screen including an advertisement according to an embodiment of the disclosure.

Referring to FIG. 9, the electronic apparatus 100 may display the screen 900 including a plurality of areas 910, 920, 930, 940.

The area 910 may include searching area for keyword inputted by a user.

The area 920 may include a plurality of categories of item. For example, the news category is selected by the user.

The area 930 may include advertisement area. The area 930 may include the advertisement provided from an external server. The external server may be server providing the screen 900.

The area 940 may include content area corresponding to the category selected by the user. For example, the area 940 corresponds to the news category selected by the user.

FIG. 10 illustrates user input for blocking an advertisement according to an embodiment of the disclosure.

Referring to FIG. 10, the electronic apparatus 100 may display a screen including an advertisement area including advertisement. The screen may be corresponding to the screen 900 in the FIG. 9. While displaying the screen, the electronic apparatus 100 may receive user input for blocking the advertisement.

According to the embodiment 1010, The electronic apparatus 100 may receive the user input for blocking. The electronic apparatus 100 may display the screen including a User Interface (UI) 1011 related to function for blocking the advertisement. The UI 1011 may be a UI for inputting a user input indicating the user dislikes the advertisement. The electronic apparatus 100 may receive the user input selecting the UI 1011. Based on the user input selecting the UI 1011, the electronic apparatus 100 may identify the user dislikes the displayed advertisement.

According to the embodiment 1020, The electronic apparatus 100 may receive the user input for blocking. The user input may be swiping input on the advertisement area. The electronic apparatus 100 may receive the user input for swiping the advertisement area. Based on the user input for swiping the advertisement area being received, the electronic apparatus 100 may identify the user dislikes the displayed advertisement. The swiping input may be described as the swipe signal or the swipe input.

According to the embodiment 1030, The electronic apparatus 100 may receive the user input for blocking. The user input may be dragging input on the advertisement area. The electronic apparatus 100 may receive the user input for dragging the advertisement area. Based on the user input for dragging the advertisement area being received, the electronic apparatus 100 may identify the user dislikes the displayed advertisement. The dragging input may be described as the drag signal or the drag input.

The difference between the swiping input and the dragging input may depend on whether the user's input remains (or maintains) fixed at the first touch position for a predetermined time. Based on the user's input being remained (or maintained) fixed for less than the predetermined time at the first touch position and then moves, the electronic apparatus 100 may identify the user input as the swiping input. Based on the user's input being remained (or maintained) fixed for the predetermined time or more at the first touch position and then moves, the electronic apparatus 100 may identify the user input as the dragging input.

According to the embodiment 1040, The electronic apparatus 100 may receive the user input for blocking. The user input may be pre-determined touch signal. For example, the pre-determined touch signal includes a long-press touch signal. The electronic apparatus 100 may receive the user input indicating the pre-determined touch signal. Based on the user input indicating the pre-determined touch signal, the electronic apparatus 100 may identify the user dislikes the displayed advertisement.

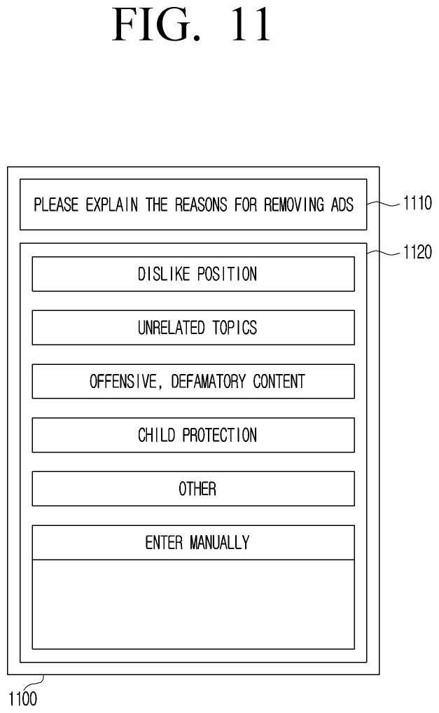

FIG. 11 illustrates a screen for user's feedback according to an embodiment of the disclosure.

Referring to FIG. 11, the electronic apparatus 100 display a screen 1100 for user's feedback. The feedback may mean the opinion of the user related with the displayed advertisement. Based on the user input for blocking the advertisement, the electronic apparatus 100 may display the screen 1100 for user's feedback. The user input for blocking the advertisement may be corresponding to the user input in the FIG. 10.

The screen 1100 may include an area 1110 and an area 1120. The area 1110 may include information guiding the user to input reasons for disliking the advertisement. The area 1120 may include at least one UI indicating at least one reasons for disliking the advertisement.

The electronic apparatus 100 may receive the user input (or the user's feedback) through the screen 1100. The electronic apparatus 100 may obtain the user input (or the user's feedback) as the user data related to the displayed advertisement. Based on the user's feedback being received through the screen 1100, the electronic apparatus 100 may store the user's feedback as the user data. The user data may include the user's feedback.

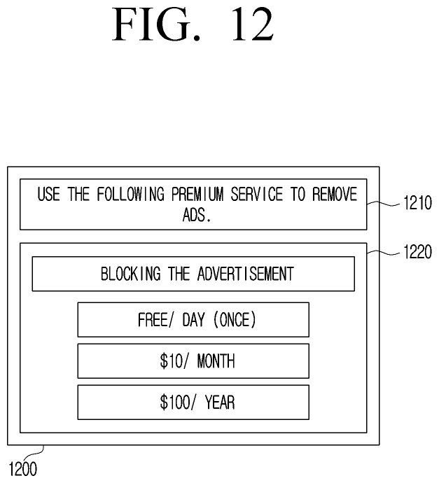

FIG. 12 illustrates a screen for purchasing a service for blocking the advertisement according to an embodiment of the disclosure.

Referring to FIG. 12, the electronic apparatus 100 may display a screen 1200 for purchasing the service for blocking the advertisement. Based on the user input for blocking the advertisement, the electronic apparatus 100 may display the screen 1200 for purchasing the service for blocking the advertisement.

The screen 1200 may include an area 1210 and an area 1220. The area 1210 may include information guiding the user to purchase the service for blocking the advertisement. The area 1220 may include at least one of services for blocking the advertisement.

The electronic apparatus 100 may receive the user input (or the user's purchase) through the screen 1200. Based on the user input for purchasing the service being received, the electronic apparatus 100 may perform the function for blocking the advertisement. After performing the function for blocking the advertisement, the electronic apparatus 100 may displaying new screen excluding the displayed advertisement.

FIG. 13 illustrates blocking operation of an electronic apparatus according to an embodiment of the disclosure.

Referring to FIG. 13, the electronic apparatus 100 may display the screen 1301 including a plurality of areas 1310, 1320, 1330, 1340. The screen 1301 may be corresponding to the screen 900 in the FIG. 9. Based on the user input for blocking the advertisement being received through the area 1330, the electronic apparatus 100 may performing the blocking operation to remove the advertisement. The electronic apparatus 100 may performing the function for blocking the advertisement.

The electronic apparatus 100 may obtain new screen 1302 based on the result in performing the function for blocking the advertisement. The new screen 1302 may be a screen excluding the area 1330. The new screen 1302 may include only the areas 1310, 1320, 1340. The electronic apparatus 100 may generated the new screen 1302 without the area 1330. The electronic apparatus 100 may display the new screen 1302.

FIG. 14 illustrates blocking operation of an electronic apparatus according to an embodiment of the disclosure.

Referring to FIG. 14, the electronic apparatus 100 may display the screen 1401 including a plurality of areas 1410, 1420, 1430, 1440. The screen 1401 may be corresponding to the screen 900 in the FIG. 9. Based on the user input for blocking the advertisement being received through the area 1430, the electronic apparatus 100 may performing the blocking operation to remove the advertisement. The electronic apparatus 100 may performing the function for blocking the advertisement.

The electronic apparatus 100 may obtain new screen 1402 based on the result in performing the function for blocking the advertisement. The new screen 1402 may be a screen with a changed advertisement. Based on the user input for blocking the advertisement being received through the area 1430, the electronic apparatus 100 may change the advertisement of the area 1430 to new advertisement based on a user preference information. The user preference information is pre-stored in the electronic apparatus 100. The electronic apparatus 100 may obtain the new screen 1402 including new area 1432 corresponding to the new advertisement. The electronic apparatus 100 may obtain the new screen 1402 including the areas 1410, 1420, 1432, 1440.

FIG. 15 illustrates operation for storing a sub model according to an embodiment of the disclosure.

Referring to FIG. 15, the server 200 may obtain first advertisement training data at operation S1510. The server 200 may train a first main model for blocking the advertisement based on the first advertisement training data at operation S1511. The server 200 may obtain the first main model based on the result in the training operation.

The server 200 may train a first sub model corresponding to the first main model based on Knowledge Distillation at operation S1512. The server 200 may train the first sub model by performing the function of the Knowledge Distillation. The Knowledge Distillation may be described as Model Compression. The server 200 may obtain the first sub model based on the result in the training operation.

For example, the first main model is a teacher model and the first sub model may be a student model. In the context of the teacher model-student model relationship, the Knowledge Distillation may refer to the process where a large, pre-trained model (teacher model) transfers knowledge of the teacher model to a smaller, simpler model (student model). The student model is trained to mimic the teacher model's outputs for achieving similar performance with reduced complexity and reduced computational requirements.

The server 200 may reduce size of the first sub model based on Quantization at operation S1513. The server 200 may perform the function of the Quantization. The server 200 may obtain a reduced first sub model. The reduced first sub model may be described as the first sub model.

For example, the Quantization in AI deep learning may refer to the process of converting the weights and activations of a neural network from high precision floating-point numbers to lower precision integers (e.g. 4 bit integers). This compression technique may reduce resource of the memory and computational complexity of the model.

The server 200 may transmit the first sub model to the electronic apparatus 100 at operation S1514. The electronic apparatus 100 may receive the first sub model from the server 200. The electronic apparatus 100 may store the first sub model at operation S1515.

The electronic apparatus 100 may refer the first electronic apparatus 101 or the second electronic apparatus 102. The server 200 may communicate the first electronic apparatus 101 and the second electronic apparatus 102.

FIG. 16 illustrates operation for training a first sub model on a first electronic apparatus according to an embodiment of the disclosure.

Referring to FIG. 16, operations S1614 and S1615 may correspond to the operations S1514 and S1515 in FIG. 15.

After storing the first sub model, the first electronic apparatus 101 may display a first screen at operation S1620. The first screen may include advertisement area. The first screen may be corresponding to the screen 900 in FIG. 9.

The first electronic apparatus 101 may obtain a first user input for blocking the advertisement through the displayed screen at operation S1621. Based on the first user input being received through the displayed screen, the first electronic apparatus 101 may perform the function for the blocking the advertisement. The first electronic apparatus 101 may input the first screen and the first user input into the first sub model stored in the first electronic apparatus 101.

The first electronic apparatus 101 may obtain the second screen as inputting the first screen and the first user input into the first sub model at operation S1622. The second screen is a screen as the result in the function for blocking the advertisement. The first electronic apparatus 101 may display the second screen at operation S1623. The second screen may be a screen without advertisement area. It is described in FIG. 13. The second screen may be a screen with a changed advertisement area. It is described in FIG. 14.

The first electronic apparatus 101 may determine whether a first pre-determined event is identified at operation S1630. The first pre-determined event may be one event among the plurality of pre-determined events.

The plurality of pre-determined events may include an event that receives a user input for blocking the advertisement. The user input may be a pre-determined type among a plurality of types. The plurality of types may be described in FIG. 10.

The plurality of pre-determined events may include an event that receives a user input for re-training the first main model or the first sub model.

The plurality of pre-determined events may include an event for executing a training mode related to the function for blocking the advertisement.

The plurality of pre-determined events may include an event indicating that a pre-determined period is (has) elapsed. The first electronic apparatus 101 may store at least one of screens and at least one of user inputs while the pre-determined period.

Based on the first pre-determined event not being identified on the first electronic apparatus 101 at operation S1630-N, the first electronic apparatus 101 may perform the operations S1620, S1621, S1622, S1623, S1630 again.

Based on the first pre-determined event being identified on the first electronic apparatus 101 at operation S1630-Y, the first electronic apparatus 101 may obtain first user data including at least one of the first screen, the second screen or the first user input at operation S1631.

For one example, the first user data may include only the first screen.

For one example, the first user data may include the first screen and the first user input.

For one example, the first user data may include the first screen, the second screen and the first user input.

The first electronic apparatus 101 may obtain a second sub model by re-training the first sub model based on the first user data at operation S1632. The first electronic apparatus 101 may re-train the first sub model based on the first user data. The first electronic apparatus 101 may generate the second sub model by re-training the first sub model.

The first electronic apparatus 101 may determine whether a second pre-determined event is identified at operation S1640. Based on the second pre-determined event not being identified at operation S1640-N, the first electronic apparatus 101 may perform the operations S1620, S1621, S1622, S1623, S1630, S1631, S1632, S1640 again.

The second pre-determined event may be one event among the plurality of pre-determined events. The plurality of pre-determined events may be corresponding to evets in operation S1630.

In one embodiment, the first pre-determined event may be the same as the second pre-determined event.

In one embodiment, the first pre-determined event may be different from the second pre-determined event. For example, the first pre-determined event may be an event for executing the training mode related to the function for blocking the advertisement and the second pre-determined event may be an event indicating that the pre-determined period is (has) elapsed.

Based on the second pre-determined event being identified at operation S1640-Y, the first electronic apparatus 101 may transmit the second sub model to the server 200 at operation S1641-1. The server 200 may receive the second sub model from the first electronic apparatus 101. The server 200 may store the second sub model at operation S1642-1.

The transmitted second sub model may be described as information related to the second sub model. The information is used for the re-training of the main model. The transmitted second sub model may be described as second sub model information or information of the second sub model.

According to another embodiment, the first electronic apparatus 101 may transmit the first user data without re-training operation at operation S1632. The server 200 may receive the first user data. The server 200 may re-train the first main model based on the first user data.

According to another embodiment, the operations S1630, S1640 may be omitted. The first electronic apparatus 101 may continuously obtain the first user data after displaying the second screen. The first electronic apparatus 101 may continuously transmit the second sub model after obtaining the second sub model.

FIG. 17 illustrates operation for training a first sub model on a second electronic apparatus according to an embodiment of the disclosure.

Referring to FIG. 17, operation S1714 and operation S1715 may correspond to the operations S1514 and S1515 in FIG. 15.

After storing the first sub model, the second electronic apparatus 102 may display a third screen at operation S1720. The third screen may include advertisement area. The third screen may be corresponding to the screen 900 in FIG. 9.

The second electronic apparatus 102 may obtain a second user input for blocking the advertisement through the displayed screen at operation S1721. Based on the second user input being received through the displayed screen, the second electronic apparatus 102 may perform the function for the blocking the advertisement. The second electronic apparatus 102 may input the third screen and the second user input into the first sub model stored in the second electronic apparatus 102.

The second electronic apparatus 102 may obtain the fourth screen as inputting the third screen and the second user input into the first sub model at operation S1722. The fourth screen is a screen as the result in the function for blocking the advertisement. The second electronic apparatus 102 may display the fourth screen at operation S1723. The fourth screen may be a screen without advertisement area. It is described in FIG. 13. The fourth screen may be a screen with a changed advertisement area. It is described in FIG. 14.

The second electronic apparatus 102 may determine whether a first pre-determined event is identified at operation S1730. The first pre-determined event may be one event among the plurality of pre-determined events.

The plurality of pre-determined events may include an event that receives a user input for blocking the advertisement. The user input may be a pre-determined type among a plurality of types. The plurality of types may be described in FIG. 10.

The plurality of pre-determined events may include an event that receives a user input for re-training the first main model or the first sub model.

The plurality of pre-determined events may include an event for executing a training mode related to the function for blocking the advertisement.

The plurality of pre-determined events may include an event indicating that a pre-determined period is (has) elapsed. The second electronic apparatus 102 may store at least one of screens and at least one of user inputs while the pre-determined period.

Based on the first pre-determined event not being identified on the second electronic apparatus 102 at operation S1730-N, the second electronic apparatus 102 may perform the operations S1720, S1721, S1722, S1723, S1730 again.

Based on the first pre-determined event being identified on the second electronic apparatus 102 at operation S1730-Y, the second electronic apparatus 102 may obtain second user data including at least one of the third screen, the fourth screen or the second user input at operation S1731.

For one example, the second user data may include only the third screen.

For one example, the second user data may include the third screen and the second user input.

For one example, the second user data may include the third screen, the fourth screen and the second user input.

The second electronic apparatus 102 may obtain a third sub model by re-training the first sub model based on the second user data at operation S1732. The second electronic apparatus 102 may re-train the first sub model based on the second user data. The second electronic apparatus 102 may generate the third sub model by re-training the first sub model.

The second electronic apparatus 102 may determine whether a second pre-determined event is identified at operation S1740. Based on the second pre-determined event not being identified at operation S1740-N, the second electronic apparatus 102 may perform the operations S1720, S1721, S1722, S1723, S1730, S1731, S1732, S1740 again.

The second pre-determined event may be one event among the plurality of pre-determined events. The plurality of pre-determined events may be corresponding to evets in operation S1730.

In one embodiment, the first pre-determined event may be the same as the second pre-determined event.

In one embodiment, the first pre-determined event may be different from the second pre-determined event. For example, the first pre-determined event may be an event for executing the training mode related to the function for blocking the advertisement and the second pre-determined event may be an event indicating that the pre-determined period is (has) elapsed.

Based on the second pre-determined event being identified at operation S1740-Y, the second electronic apparatus 102 may transmit the third sub model to the server 200 at operation S1741-1. The server 200 may receive the third sub model from the second electronic apparatus 102. The server 200 may store the third sub model at operation S1742-2.

The transmitted third sub model may be described as information related to the third sub model. The information is used for the re-training of the main model. The transmitted third sub model may be described as third sub model information or information of the third sub model.

According to another embodiment, the second electronic apparatus 102 may transmit the second user data without re-training operation at operation S1732. The server 200 may receive the second user data. The server 200 may re-train the first main model based on the second user data.

According to another embodiment, the operations S1730, S1740 may be omitted. The second electronic apparatus 102 may continuously obtain the second user data after displaying the fourth screen. The second electronic apparatus 102 may continuously transmit the third sub model after obtaining the third sub model.

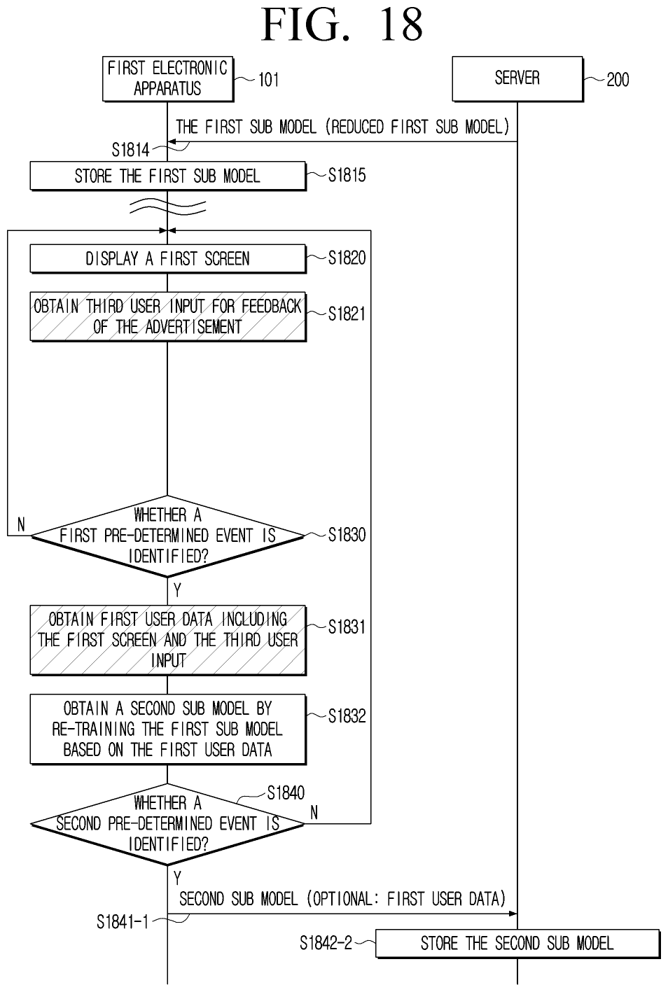

FIG. 18 illustrates operation for training a sub model without changing a screen according to an embodiment of the disclosure.

Referring to FIG. 18, operations S1814, S1815, S1815, S1820, S1830, S1832, S1840, S1841-1, S1842-2 may correspond to the operations S1614, S1615, S1615, S1620, S1630, S1632, S1640, S1641-1, S1642-2.

After displaying the first screen at operation S1820, the first electronic apparatus 101 may obtain a third user input for feedback of the advertisement at operation S1821. The feedback is described in FIG. 11. The third user input may indicate user's preference corresponding an advertisement included in the displayed screen. The third user input may include reason for disliking the advertisement.

Based on the third user input being received, the first electronic apparatus 101 may determine whether a first pre-determined event is identified at operation S1830.

Based on the first pre-determined event being identified, the first electronic apparatus 101 may obtain first user data including the first screen and the third user input at operation S1831. The first electronic apparatus 101 may analyze the user's preference based on the first screen and the third user input.

After obtaining the first user data, the first electronic apparatus 101 may perform operations S1832, S1840, S1841-1, S1842-2.

FIG. 19 illustrates operation for training a first main model on a server according to an embodiment of the disclosure.

Referring to FIG. 19, operations S1941-1 and S1942-1 may correspond to the operations S1641-1 and S1642-1 in FIG. 16.

The operations S1941-2 and S1942-2 may be corresponding to the operations S1741-2 and S1742-2 in FIG. 17.

The server 200 may receive the second sub model from the first electronic apparatus 101. The server 200 may receive the third sub model from the second electronic apparatus 102.

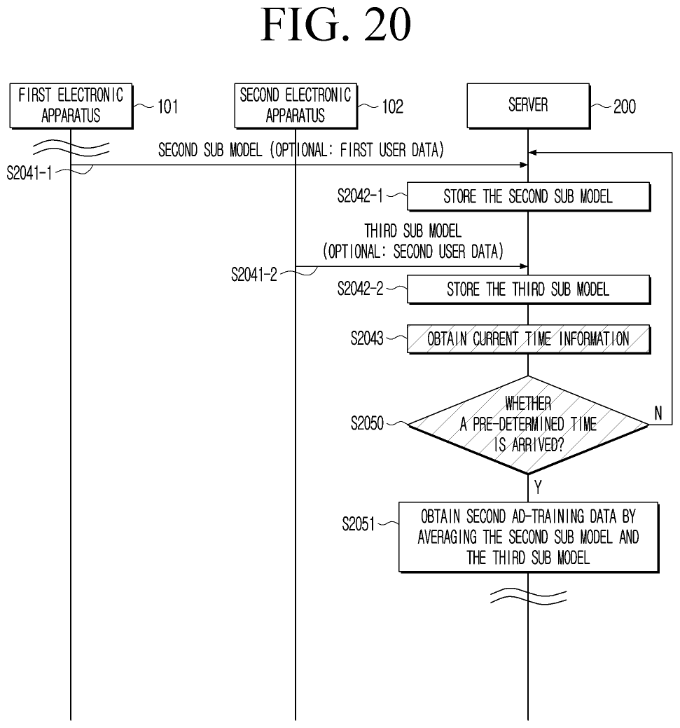

The server 200 may determine whether a third pre-determined event is identified at operation S1950. The third pre-determined event may be one event among the plurality of pre-determined events. The third pre-determined event may be described in FIGS. 20, 21, 22, and 23.

Based on the third pre-determined event not being identified at operation S1950-N, the server 200 may perform the operations S1942-1, S1942-2, S1950.

Based on the third pre-determined event being identified at operation S1950-Y, the server 200 may obtain second advertisement training data by averaging the second sub model and the third sub model at operation S1951.

The Averaging operation may be a process in machine learning where data or parameters from a plurality of student models (sub models) are consolidated to enhance the training of a teacher model (main model). The information obtained from several student models is aggregated to form a unified dataset or parameter set. This unified data may be used to update and improve the teacher model. By combining the insights and learned patterns from each student model, the Averaging operation helps in creating a more robust and accurate teacher model.

The server 200 may obtain a second main model by re-training the first main model for blocking the advertisement based on the second advertisement training data at operation S1952. The server 200 may train a fourth sub model corresponding to the second main model based on a Knowledge Distillation at operation S1953.

The server 200 may reduce size of the fourth sub model based on a Quantization at operation S1954. The Quantization operation may be described in FIG. 15.

The server 200 may transmit the fourth sub model to the first electronic apparatus 101 at operation S1955-1. The transmitted fourth sub model may be described as the reduced fourth sub model. The first electronic apparatus 101 may receive the fourth sub model from the server 200. The first electronic apparatus 101 may store the fourth sub model at operation S1956-1.

The server 200 may transmit the fourth sub model to the second electronic apparatus 102 at operation S1955-2. The transmitted fourth sub model may be described as the reduced fourth sub model. The second electronic apparatus 102 may receive the fourth sub model from the server 200. The second electronic apparatus 102 may store the fourth sub model at operation S1956-2.

FIG. 20 illustrates a third pre-determined event according to an embodiment of the disclosure.

Referring to FIG. 20, operations S2041-1, S2042-1, S2041-2, S2042-2, S2051 may correspond to the operations S1941-1, S1942-1, S1941-2, S1942-2, S1951.

After storing the second sub model and the third sub model, the server 200 may obtain the current time information at operation S2043.

The server 200 may determine whether a pre-determined time has arrived at operation S2050. The third pre-determined event may include an event that the pre-determined time has arrived. Based on the pre-determined time having arrived, the server 200 may identify the third pre-determined event has occurred.

Based on the pre-determined time having arrived, the server 200 may obtain second advertisement training data by averaging the second sub model and the third sub model at operation S2051.

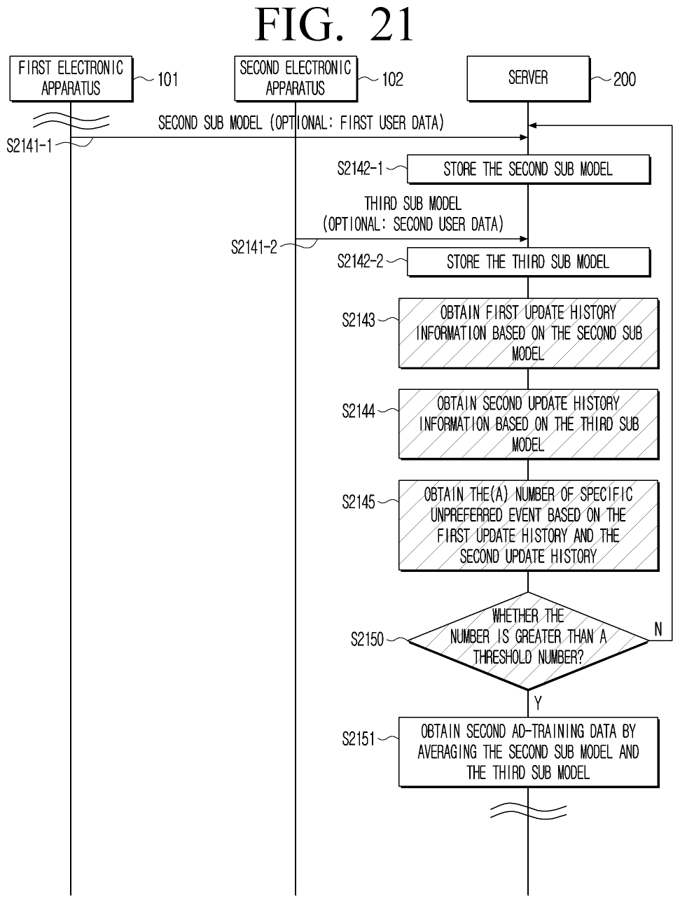

FIG. 21 illustrates a third pre-determined event according to an embodiment of the disclosure.

Referring to FIG. 21, operations S2141-1, S2142-1, S2141-2, S2142-2, S2151 be correspond to the operations S1941-1, S1942-1, S1941-2, S1942-2, S1951.

After storing the second sub model and the third sub model, the server 200 may obtain first update history information based on the second sub model at operation S2143. The server 200 may obtain second update history information based on the third sub model at operation S2144.

The update history information may include at least one of unpreferred sites, unpreferred advertisement position and unpreferred advertisement category. The server 200 may analyze the update history information. The server 200 may identify a specific unpreferred event has occurred.

The server 200 may obtain the (a) number of specific unpreferred event based on the first update history information and the second update history information at operation S2145.

The server 200 may determine whether the number is greater than a threshold number at operation S2150. The third pre-determined event may include an event that the number the specific unpreferred event is greater than the threshold number. Based on the number being greater than the threshold number the server 200 may identify the third pre-determined event has occurred.

Based on the number being greater than the threshold number, the server 200 may obtain second advertisement training data by averaging the second sub model and the third sub model at operation S2151.

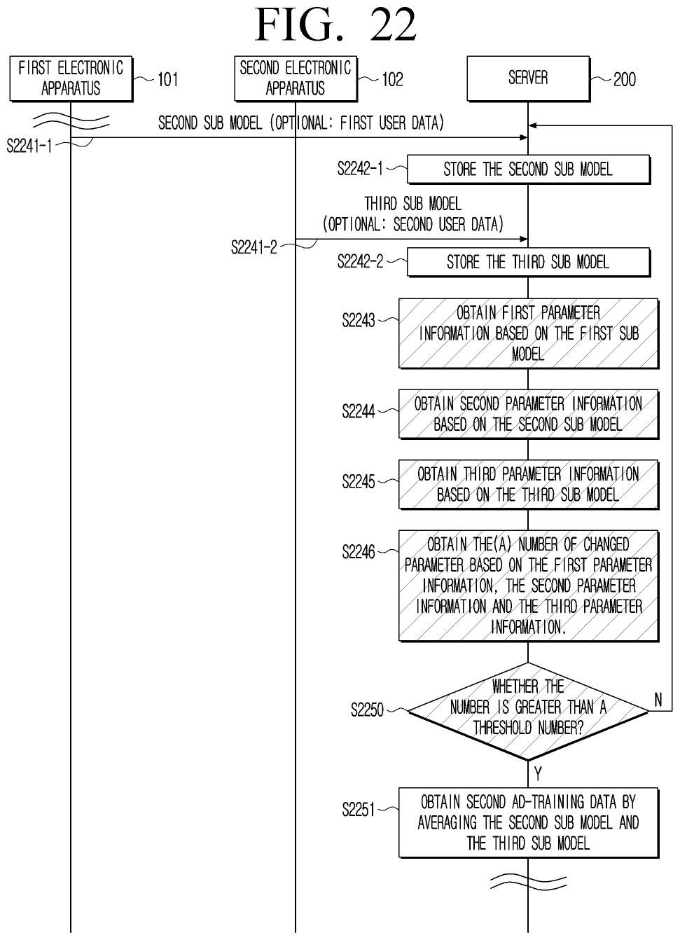

FIG. 22 illustrates a third pre-determined event according to an embodiment of the disclosure.

Referring to FIG. 22, operations S2241-1, S2242-1, S2241-2, S2242-2, S2251 may correspond to the S1941-1, S1942-1, S1941-2, S1942-2, S1951.

The server 200 may store first parameter information based on the first sub model.

After storing the second sub model and the third sub model, the server 200 may obtain the first parameter information at operation S2243. The server 200 may obtain second parameter information based on the second sub model at operation S2244. The server 200 may obtain second parameter information based on the third sub model at operation S2245.

The parameter information may include at least one parameter of the sub model. The parameter is related to the function for blocking the advertisement through the sub model.

The server 200 may obtain the (a) number of changed parameter based on the first parameter information, the second parameter information and the third parameter information at operation S2246.

The server 200 may compare between the first parameter information of the first sub model and the second parameter information of the second sub model. The server 200 may obtain a first result based on the comparison. The first result may include first changed value between the first parameter information and the second parameter information. The first changed value may be an average changed value of at least one parameter in the first parameter information and the second parameter information. The server 200 may determine whether the first changed value is greater than a threshold value. Based on the first changed value being greater than the threshold value, the server 200 may count the number of changed parameter.

The server 200 may compare between the first parameter information of the first sub model and the third parameter information of the third sub model. The server 200 may obtain a second result based on the comparison. The second result may include second changed value between the first parameter information and the third parameter information. The second changed value may be an average changed value of at least one parameter in the first parameter information and the third parameter information. The server 200 may determine whether the second changed value is greater than a threshold value. Based on the second changed value being greater than the threshold value, the server 200 may count the number of changed parameter.

The server 200 may determine whether the number is greater than a threshold number at operation S2250. The third pre-determined event may include an event that the number the changed parameter is greater than the threshold number. Based on the number being greater than the threshold number the server 200 may identify the third pre-determined event has occurred.

Based on the number being greater than the threshold number, the server 200 may obtain second advertisement training data by averaging the second sub model and the third sub model at operation S2251.

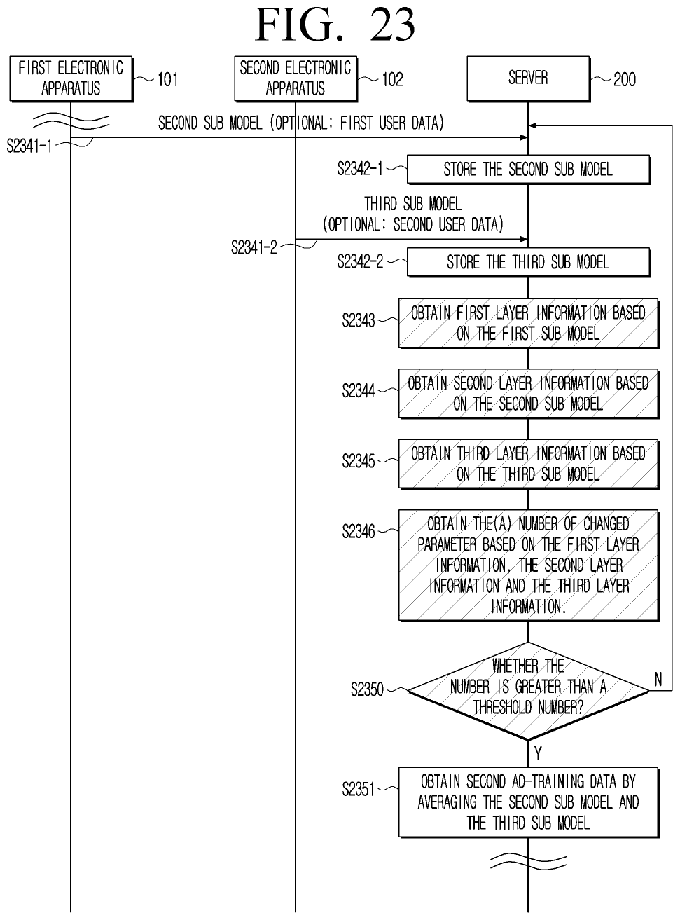

FIG. 23 illustrates a third pre-determined event according to an embodiment of the disclosure.

Referring to FIG. 23, operations S2341-1, S2342-1, S2341-2, S2342-2, S2351 may correspond to the S1941-1, S1942-1, S1941-2, S1942-2, S1951.

The server 200 may store first layer information based on the first sub model.

After storing the second sub model and the third sub model, the server 200 may obtain the first layer information at operation S2343. The server 200 may obtain second layer information based on the second sub model at operation S2344. The server 200 may obtain second layer information based on the third sub model at operation S2345.

The layer information may include at least one layer of the sub model. The layer is related to the function for blocking the advertisement through the sub model. The layer information is related to the structure of the sub model. The sub model may include a plurality of layers.

The server 200 may obtain the (a) number of changed layer based on the first layer information, the second layer information and the third layer information at operation S2346.

The server 200 may compare between the first layer information of the first sub model and the second layer information of the second sub model. The server 200 may obtain a first result based on the comparison. The first result may include first changed value between the first layer information and the second layer information. The first changed value may be an average changed value of at least one layer in the first layer information and the second layer information. The server 200 may determine whether the first changed value is greater than a threshold value. Based on the first changed value being greater than the threshold value, the server 200 may count the number of changed layer.

The server 200 may compare between the first layer information of the first sub model and the third layer information of the third sub model. The server 200 may obtain a second result based on the comparison. The second result may include second changed value between the first layer information and the third layer information. The second changed value may be an average changed value of at least one layer in the first layer information and the third layer information. The server 200 may determine whether the second changed value is greater than a threshold value. Based on the second changed value being greater than the threshold value, the server 200 may count the number of changed layer.

The server 200 may determine whether the number is greater than a threshold number at operation S2350. The third pre-determined event may include an event that the number the changed layer is greater than the threshold number. Based on the number being greater than the threshold number the server 200 may identify the third pre-determined event has occurred.

Based on the number being greater than the threshold number, the server 200 may obtain second advertisement training data by averaging the second sub model and the third sub model at operation S2351.

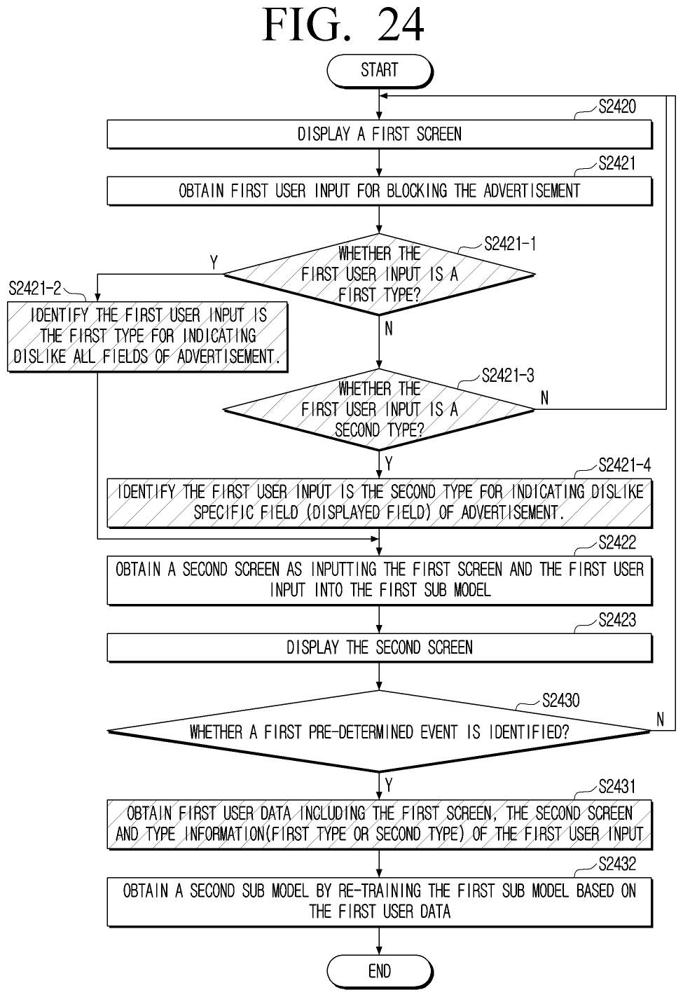

FIG. 24 illustrates operation of using type information of a user input according to an embodiment of the disclosure.

Referring to FIG. 24, operations S2420, S2421, S2422, S2423, S2430, S2432 may correspond to the operations S1620, S1621, S1622, S1623, S1630, S1632 in FIG. 16.

After obtaining the first user input, the first electronic apparatus 101 may determine the first user input is a first type at operation S2421-1. The first type is pre-determined type.

Based on the first user input being the first type at operation S2421-1-Y, the first electronic apparatus 101 may identify the first user input is the first type for indicating dislike all fields of advertisement at operation S2421-2. The first electronic apparatus 101 may perform the operations S2422, S2423, S2430.

Based on the first user input not being the first type at operation S2421-1-N, the first electronic apparatus 101 may determine whether the first user input is a second type at operation S2421-3. The second type may be pre-determined type.

Based on the first user input not being the second type at operation S2421-3-N, the first electronic apparatus 101 may perform the operations S2420, S2421, S2421-1, S2421-2, S2421-3.

Based on the first user input being the second type at operation S2421-3-Y, the first electronic apparatus 101 may identify the first user input is the second type for indicating dislike specific field (displayed field) of advertisement at operation S2421-4. The first electronic apparatus 101 may perform the operations S2422, S2423, S2430.

Based on the first pre-determined event being identified at operation S2430-Y, the first electronic apparatus 101 may obtain first user data including the first screen, the second screen and type information of the first user input at operation S2431. The type information of the first user input may indicate the first user input corresponds a particular type. The type information may include the first type or the second type.

The first electronic apparatus 101 may obtain a second sub model by re-training the first sub model based on the first user data at operation S2432.

FIG. 25 illustrates a main model according to an embodiment of the disclosure.

Referring to FIG. 25, according to an embodiment 2500, the server 200 may obtain training data 2501 as input data. The training data 2501 may include a screen including advertisement.

The server 200 may transmit the training data 2501 to the first API 2510. The first API 2510 may be module of extracting HTML elements. The first API 2510 may obtain HTML element (e.g. HTML document) of the training data 2501. The HTML element may be obtained through a HTML DOM tree method. The first API 2510 may transmit the HTML element to the main model 210.

The HTML Document Object Model (DOM) tree may be a hierarchical representation of an HTML document. HTML DOM tree may structure the document as a tree of objects, where each node represents a part of the document, such as elements, attributes, or text. HTML DOM tree may allow programming languages to manipulate the structure, style, and content of the document dynamically.

The server 200 may transmit the training data 2501 to the second API 2520. The second API 2520 may be module of extracting HTML elements. The second API 2520 may obtain network element of the training data 2501. The network element may include requests related to the network. The request is a process where a browser or application communicates with a web server to fetch resources such as HTML, images, or scripts. The second API 2520 may obtain the network element based on the network inspector logs (log data or log information). The second API may transmit the network element to the main model 210.

The main model 210 may obtain the HTML element from the first API 2510. The main model 210 may obtain the network element from the second API 2520. The main model may train for outputting a screen without the advertisement based on the HTML element and the network element. The main model 210 may obtain output data 2502 including a screen without the advertisement.

FIG. 26 illustrates operation for training model according to an embodiment of the disclosure.

Referring to FIG. 26, according to an embodiment 2610, the main model 210 may be trained based on training loss. The server 200 may transmit input data (Xin) into CodeGen module 2611. The data (Xin) may be screen data including advertisement.

The CodeGen module 2611 may obtain prediction information for generating code automatically. The CodeGen module 2611 may transmit the prediction information into a LossFunction module 2612. The LossFunction module 2612 may receive the prediction information from the CodeGen module 2611. The LossFunction module 2612 may obtain the output data (Yin). The output data (Yin) may be screen data without the advertisement.

The LossFunction module 2612 may obtain the training loss based on a difference between the prediction information and the output data (Yin).

The server 200 may train the main model 210 based on the training loss.

In an embodiment, the electronic apparatus 100 may train the sub model based on the method in FIG. 26.

According to an embodiment 2620, server 200 may obtain the sub model corresponding to the main model. The main model may be teacher model and the sub model may be student model.

The main model may obtain soft labelled data based on the input data (Xin) through a Softmax layer.

The sub model may obtain soft (simple) prediction information based on the input data (Xin) through a Softmax layer. The soft (simple) prediction information may be described as first prediction information.

The sub model may obtain hard (detailed) prediction information based on the input data (Xin) through a Softmax layer. The hard (detailed) prediction information may be described as second prediction information.

The LossFunction module 2612 may include a first LossFunction module 2612-1 and a second LossFunction module 2612-2. The first LossFunction module 2612-1 may obtain a distillation loss based the soft labelled data and the soft (simple) prediction information. The second LossFunction module 2612-2 may obtain training loss based on the hard (detailed) prediction information and the output data (Yin).

The server 200 may obtain a total loss based on the distillation loss and the training loss. The server 200 may train the main mode and the sub model based on the total loss.

According to an embodiment 2630, the server 200 may include quantization function module 2631. The quantization function module 2631 may perform the INT4 Quantization operation in FIG. 8.

FIG. 27 illustrates operation for Adapter (sub model) Training according to an embodiment of the disclosure.

Referring to FIG. 27, according to an embodiment 2710, electronic apparatus 100 may train the sub model. The electronic apparatus 100 may use Low-Rank (LoRA) Adapters to train (or learn) the personalization preferences of a user.

The electronic apparatus 100 may inject low-rank decomposition matrices in the multi-head-attention layers. The electronic apparatus 100 may train the sub model using the stored user data.

The electronic apparatus 100 may obtain an adapter that may be attached to the sub model. The electronic apparatus 100 may alter its behavior such that future ad-blocking on a user's device may match the individual user's preferences.

As the sub model may be quantized, all training operation may be occurred on-device (e.g. electronic apparatus 100). In addition, we use Differentially-Private-Stochastic Gradient Descent (DP-SGD) to guarantee differential privacy on the obtained adapter.

According to an embodiment 2720, the electronic apparatus 100 may store multi-head attention layer with LoRA Adapters. The multi-head attention layer with LoRA Adapters may use Query, Key, and Value data to calculate the output data.

FIG. 28 illustrates operation for updating a sub model according to an embodiment of the disclosure.

Referring to FIG. 28, the electronic apparatus 100 may obtain a user report. The user report may be a user input in FIG. 10. The user report may include a user data in FIGS. 11 and 16. The user report may include user preference corresponding to advertisement.

The electronic apparatus 100 may transmit the user report to the server 200. The server 200 may obtain the user report from the electronic apparatus 100.

In an embodiment 2810, the electronic apparatus 100 may a plurality of apparatuses. The plurality of apparatuses may transmit at least one user report to the server 200. The server 200 may receive the at least one user report from the plurality of apparatuses.

The server 200 may combine (or merge) the at least one user report. The server 200 may perform operation of averaging to update the main model. The server 200 may obtain user preference corresponding to advertisement based on the at least one user report. The server 200 may obtain the (a) number of the blocking a specific advertisement based on the user preference. Based on the number of the blocking a specific advertisement being greater than a threshold number, the server 200 may update the main model. The number of the blocking a specific advertisement may be used as update trigger of the main model. To detect update trigger, the server 200 may keep a Differentially Private database of user advertisement preferences (e.g. simple counters).

In an embodiment 2820, it is also possible to use the adapter's decomposition matrices as proxies for a user's preferences since the adapter has learned these on device. A method for comparing the distance between user adapters and the main model in vector space may be used as an alternative trigger for updating, but this requires further research. Note that this method does not require additional privacy measures as the adapters are differentially private by default, which guarantees the privacy of a vector metric-based update trigger.

In an embodiment 2830, one advantage of using LoRA is that the adapter (which are decomposition matrices) can be merged into the weights of the model itself. When an update trigger is issued, the server 200 may simply pull all of the users' personal adapters from their devices, perform Soup-style Model Averaging, and merge the averaged adapter into the main model. The server 200 may update the sub model in the plurality of apparatuses with the new sub model. Every user's adapter is trained with DP-SGD, the entire automatic update process is guaranteed to be differentially private.

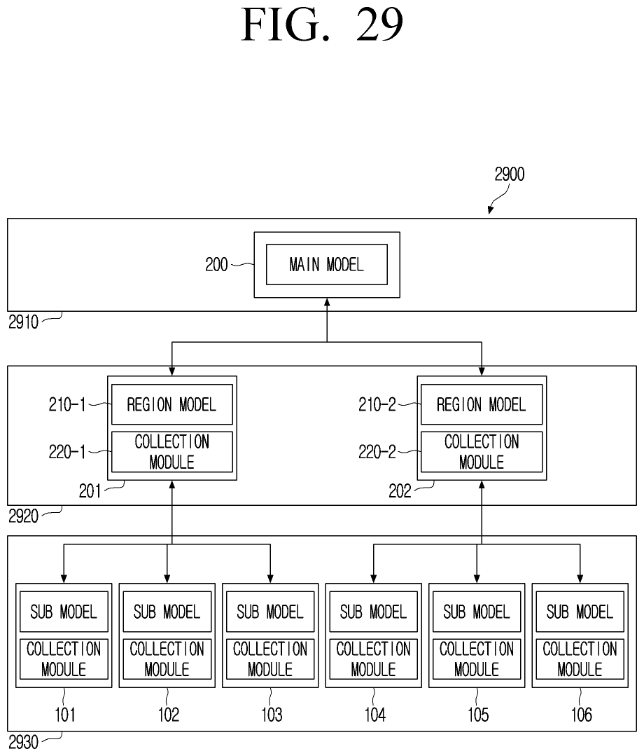

FIG. 29 illustrates Region-based Hierarchical Distribution according to an embodiment of the disclosure.

Referring to FIG. 29, according to an embodiment 2900, raw data may not leave the subscriber device and training makes use of differentially private techniques which ensures subscriber privacy at all times. Similar to the user data, region-specific data may not leave the regional servers. This personalization may be extended to region-specific content filtering.

The disclosure extends the subsystems to have a multi-level hierarchy which includes (2910) AIM Module, (2920), Region-specific Adapters (RSA), and (2930) Adapter-based Personalization and Updating.

The Aim module may be described as the main model. The Region-specific Adapters may be described as a region model. The Adapter-based Personalization and Updating may be described as the sub model.

In a first level 2910, the server 200 may include a main model. The main model may be at the General Upstream.

In a second level 2920, region servers 201, 202 may include region model 210-1, 210-2 and collection module 220-1, 220-2.

The collection module 220-1, 220-2 may utilize the collected learned knowledge of the sub models of a plurality of electronic apparatuses 101, 102, 103, 104, 105, 106 under the region. Region-specific preferences may be manually labelled by the region servers 201, 202. The region servers 201, 202 may training the region model 210-1, 210-2. The region servers 201, 202 may use the region model 210-1, 210-2 to learn preferences using the collected learned knowledge from the user data as well as specific Region-specific preferences. The region servers 201, 202 may perform the operation of averaging to group the region model 210-1, 210-2. The region servers 201, 202 may transmit the grouped information, resulted in the operation of averaging, into the main model when an update trigger is issued.

In a third level 2930, a plurality of electronic apparatuses 101, 102, 103, 104, 105, 106 may be connect at least one server among the region servers 201, 202.

The plurality of electronic apparatuses 101, 102, 103, 104, 105, 106 may be described as the electronic apparatus 100. The electronic apparatus 100 may obtain user data. User advertisement preference is collected as training data for further fine-tuning which are used to subsequent sub model training. The user data never leaves the device to ensure privacy among the electronic apparatus 100.

The electronic apparatus 100 may train the sub model. The electronic apparatus 100 may use the sub model to learn preferences using the collected user data. The training employs differential privacy techniques to ensure an inherently private sub model.

The electronic apparatus 100 may update the region model 210-1, 210-2.

The electronic apparatus 100 may perform operation of averaging to aggregate learned sub model into the region model when an update trigger is issued.

The electronic apparatus 100 may transmit the aggregated information, resulted in the operation of averaging, to the region servers 201, 202.

The region servers may include a first region server 201 and a second region server 202. The first region server 201 may connect a plurality of electronic apparatuses 101, 102, 103. The second region server 202 may connect a plurality of electronic apparatuses 104, 105, 106.

The server 200 may determine whether network element (e.g. network requests) and HTML element (e.g. web element) are advertisements or not which shall be filtered accordingly.

Similar to the embodiment in FIG. 6, the embodiment 2900 also allows for the users to manually label web elements to specify if they are advertisement or not. This personalization is then used to automatically update the region model 210-1, 210-2.

The region servers 201, 202 may manually label if certain elements are advertisement or not or implicitly obtain information from downstream subscribers (e.g., electronic apparatuses 101, 102, 103, 104, 105, 106).

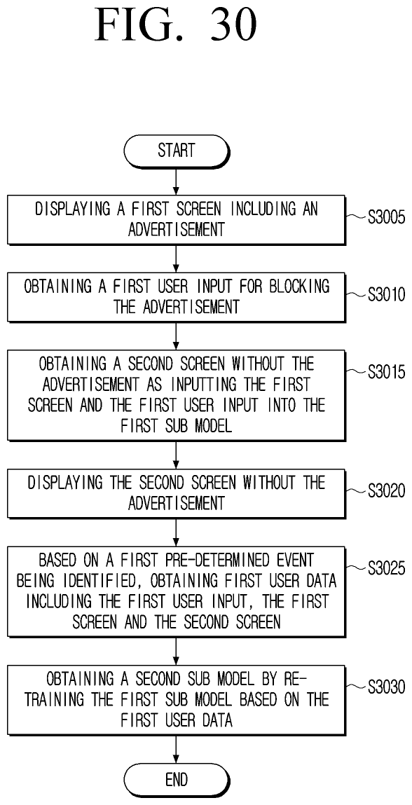

FIG. 30 illustrates controlling method of the electronic apparatus 100 according to an embodiment of the disclosure.

Referring to FIG. 30, a controlling method of an electronic apparatus 100 storing a first sub model corresponding to a main model, wherein the main model is stored in a server 200, and wherein the first sub model is obtained by reducing a size of the main model, the method comprises displaying a first screen including an advertisement at operation S3005, obtaining a first user input for blocking the advertisement at operation S3010, obtaining a second screen without the advertisement as inputting the first screen and the first user input into the first sub model at operation S3015, displaying the second screen without the advertisement at operation S3020, based on a first pre-determined event being identified, obtaining first user data including the first user input, the first screen and the second screen at operation S3025, and obtaining a second sub model by re-training the first sub model based on the first user data at operation S3030.

The main model may be obtained by training on the server 200. The first sub model may be obtained by training the main model, on the server 200, based on at least one of Knowledge Distillation or Quantization.

The method further comprises receiving the first sub model from the server 200, and storing the first sub model.

The obtaining the second screen at operation S3030 comprises obtaining the second screen by performing a function for blocking an advertisement through the first sub model.

The first pre-determined event may include an event for executing a training mode related to the function for blocking the advertisement of the sub model.

The method further comprises, based on a second pre-determined event being identified, transmitting the second sub model to the server 200.

The second pre-determined event may include an event indicating that a pre-determined period has elapsed.

The first sub model may be stored in another electronic apparatus 102. The server 200 may receive a third sub model from the other electronic apparatus 102. The third sub model may be obtained by re-training the first sub model based second user data of the other electronic apparatus 102.

The method further comprises receiving a fourth sub model from the server 200, storing the fourth sub model in the memory. The main model is a first main model. The fourth sub model may be obtained by re-training a second main model, on the server 200, based on at least one of Knowledge Distillation or Quantization. The second main model may be obtained by re-training the first main model, on the server 200, based on the second sub model and the third sub model.

The method further comprises obtaining a HTML element and a network element based on the first screen. The obtaining the second screen at operation S3030 comprises obtaining the second screen without the advertisement as inputting the HTML element, the network element and the first user input into the first sub model.

The various example methods according to the various embodiments of the disclosure described above may be implemented in the form of an application installable on an existing electronic apparatus.

The example methods according to the various embodiments of the disclosure described above may be implemented by upgrading software or hardware of the existing electronic apparatus.

The various embodiments of the disclosure described above may also be performed through an embedded server included in the electronic apparatus, or an external server of at least one of the electronic apparatus or a display device.

According to an embodiment of the disclosure, the various embodiments described hereinabove may be implemented by software including instructions that are stored in machine (e.g., a computer)-readable storage media. The machine is an apparatus that invokes the stored instructions from the storage media and is operable according to the invoked instructions, and may include the electronic apparatus according to the disclosed embodiments. When the commands are executed by the processor, the processor may perform functions corresponding to the commands, either directly or using other components under the control of the processor. The commands may include codes made by a compiler or codes executable an interpreter. The machine-readable storage medium may be provided in the form of a non-transitory storage medium. The ‘non-transitory’ storage medium may not include a signal and is tangible, and does not distinguish whether data is stored semi-permanently or temporarily in the storage medium.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
memory configured to store a first sub model corresponding to a main model and one or more computer programs, the main model being stored in a server, and the first sub model being obtained by reducing a size of the main model;
communication circuitry configured to communicate with the server including the main model;
a display; and
one or more processors communicatively coupled to the communication circuitry, the display, and the memory,
wherein the one or more computer programs include computer-executable instructions that, when executed by the one or more processors individually or collectively, cause the electronic apparatus to:
control the display to display a first screen including an advertisement,
obtain a first user input for blocking the advertisement,
obtain a second screen without the advertisement as inputting the first screen and the first user input into the first sub model,
control the display to display the second screen without the advertisement,
based on a first pre-determined event being identified, obtain first user data including the first user input, the first screen and the second screen, and
obtain a second sub model by re-training the first sub model based on the first user data.

2. The electronic apparatus of claim 1,
wherein the main model is obtained by training on the server, and
wherein the first sub model is obtained by training the main model, on the server, based on at least one of knowledge distillation or quantization.

3. The electronic apparatus of claim 1, wherein the one or more computer programs further include computer-executable instructions that, when executed by the one or more processors individually or collectively, cause the electronic apparatus to:
through the communication circuitry, receive the first sub model from the server; and
store the first sub model in the memory.

4. The electronic apparatus of claim 1, wherein the one or more computer programs further include computer-executable instructions that, when executed by the one or more processors individually or collectively, cause the electronic apparatus to:
obtain the second screen by performing a function for blocking an advertisement through the first sub model.

5. The electronic apparatus of claim 4, wherein the first pre-determined event includes an event for executing a training mode related to the function for blocking the advertisement of the first sub model.

6. The electronic apparatus of claim 1, wherein the one or more computer programs further include computer-executable instructions that, when executed by the one or more processors individually or collectively, cause the electronic apparatus to:
based on a second pre-determined event being identified, through the communication circuitry, transmit the second sub model to the server.

7. The electronic apparatus of claim 6, wherein the second pre-determined event includes an event indicating that a pre-determined period has elapsed.

8. The electronic apparatus of claim 6,
wherein the first sub model is stored in another electronic apparatus,
wherein the server receives a third sub model from the other electronic apparatus, and
wherein the third sub model is obtained by re-training the first sub model based on second user data of the other electronic apparatus.

9. The electronic apparatus of claim 8,
wherein the one or more computer programs further include computer-executable instructions that, when executed by the one or more processors individually or collectively, cause the electronic apparatus to:
through the communication circuitry, receive a fourth sub model from the server, and
store the fourth sub model in the memory,
wherein the main model is a first main model,
wherein the fourth sub model is obtained by re-training a second main model, on the server, based on at least one of knowledge distillation or quantization, and
wherein the second main model is obtained by re-training the first main model, on the server, based on the second sub model and the third sub model.

10. The electronic apparatus of claim 1, wherein the one or more computer programs further include computer-executable instructions that, when executed by the one or more processors individually or collectively, cause the electronic apparatus to:
obtain a hypertext markup language (HTML) element and a network element based on the first screen, and
obtain the second screen without the advertisement as inputting the HTML element, the network element and the first user input into the first sub model.

11. A method performed by an electronic apparatus storing a first sub model corresponding to a main model, the main model being stored in a server, and the first sub model being obtained by reducing a size of the main model, the method comprising:
displaying, by the electronic apparatus, a first screen including an advertisement;
obtaining, by the electronic apparatus, a first user input for blocking the advertisement;
obtaining, by the electronic apparatus, a second screen without the advertisement as inputting the first screen and the first user input into the first sub model;
displaying, by the electronic apparatus, the second screen without the advertisement;
based on a first pre-determined event being identified, obtaining, by the electronic apparatus, first user data including the first user input, the first screen and the second screen; and
obtaining, by the electronic apparatus, a second sub model by re-training the first sub model based on the first user data.

12. The method of claim 11,
wherein the main model is obtained by training on the server, and
wherein the first sub model is obtained by training the main model, on the server, based on at least one of knowledge distillation or quantization.

13. The method of claim 12, wherein the main model uses classic regular-expression-based ad-identifier model (AIM) to generate an advertisement-identification dataset to train a neural-network-based AIM.

14. The method of claim 13,
wherein the main model performs a teacher model training, and
wherein the main model uses a pre-trained large language model (LLM).

15. The method of claim 14, wherein the main model uses INT4 quantization to further reduce the size of the first sub model and optimize inference latency on the electronic apparatus.

16. The method of claim 11, further comprising:
receiving the first sub model from the server; and
storing the first sub model.

17. The method of claim 11, wherein the obtaining of the second screen comprises:
obtaining the second screen by performing a function for blocking an advertisement through the first sub model.

18. The method of claim 17, wherein the first pre-determined event includes an event for executing a training mode related to the function for blocking the advertisement of the first sub model.

19. One or more non-transitory computer-readable storage media storing one or more computer programs including computer-executable instructions that, when executed by one or more processors of an electronic apparatus individually or collectively, cause the electronic apparatus to perform operations, the operations comprising:
storing, by the electronic apparatus, a first sub model corresponding to a main model, the main model being stored in a server, and the first sub model being obtained by reducing a size of the main model;
displaying, by the electronic apparatus, a first screen including an advertisement;
obtaining, by the electronic apparatus, a first user input for blocking the advertisement;
obtaining, by the electronic apparatus, a second screen without the advertisement as inputting the first screen and the first user input into the first sub model;
displaying, by the electronic apparatus, the second screen without the advertisement;
based on a first pre-determined event being identified, obtaining, by the electronic apparatus, first user data including the first user input, the first screen and the second screen; and
obtaining, by the electronic apparatus, a second sub model by re-training the first sub model based on the first user data.

20. The one or more non-transitory computer-readable storage media of claim 19,
wherein the main model is obtained by training on the server, and
wherein the first sub model is obtained by training the main model, on the server, based on at least one of knowledge distillation or quantization.
